(19) United States
(12) Patent Application Publication
(10) Pub. No.: US 2014/0337053 A1
(43) Pub. Date: Nov. 13, 2014

(54) "Meaningful-Use"-Compliant, Single Login, Federated Patient Portal System and Methods

(71) Applicant: Douglas K. Smith, San Antonio, TX (US)

(72) Inventor: Douglas K. Smith, San Antonio, TX (US)

(73) Assignee: VIRTUAL VIEWBOX, INC., San Antonio, TX (US)

(21) Appl. No.: 14/205,361

(22) Filed: Mar. 11, 2014

Related U.S. Application Data
(60) Provisional application No. 61/799,613, filed on Mar. 15, 2013.

(51) Int. Cl. G06F 19/00; G06Q 40/00; H04L 29/06; G06Q 30/00

(52) U.S. Cl. CPC G06F 19/322; G06Q 30/018; G06Q 40/10; H04L 63/0861
USPC 705/3; 726/7

(57) ABSTRACT

A system and method for healthcare administration enabling a patient to simply provide a single login through the system as a trigger that permits the system to subsequently login to patient portals from a plurality of participant medical entities such as EMR networks based on the single initial login, among other operations. Specifically, a federated patient portal system assigns a meaningful use credit to a corresponding participant medical entity as the patient interacts with a user device, such as a patient medical records kiosk. The patient provides a biometric input to initiate a login session with the federated patient portal system through the user device. The biometric input enables the patient to quickly authenticate with the federated patient portal system while eliminating the need for initially providing alpha numerical text input for login.

### TECHNICAL FIELD

The present disclosure relates generally to communication systems and in particular to a system and method for governing, via a “meaningful use”-compliant, single login, federated patient portal system, patient portal access to at least one network from a plurality of medical entity networks that are platformed with the federated patient portal system, where the federated patient portal system ensures quick and simple single patient login to the plurality of medical entity networks in compliance with government regulations regarding electronic protected health information (hereinafter “ePHI”) for patients (such regulations as, among others, The Health Information Technology for Economic and Clinical Health Act (HITECH Act) of the American Recovery and Reinvestment Act of 2009 (ARRA), Public L. 111-5, enacted Feb. 17, 2009, and the Security Standards for the Protection of Electronic Protected Health Information (the ePHI Security Rule) published Feb. 20, 2003 (45 C.F.R. Part 160 and Part 164, Subparts A and C; the Health Insurance Portability and Accountability Act (hereafter “HIPAA”) (Health Insurance Portability and Accountability Act of 1996 (HIPAA); Public L. 104-191, 101 Stat. 1936, enacted Aug. 21, 1996.)).

### BACKGROUND

The Health Information Technology for Economic and Clinical Health Act (HITECH Act) as part of the American Recovery and Reinvestment Act of 2009 (ARRA). The ARRA creates a financial incentive program for physicians and healthcare providers to adopt “meaningful use” of electronic medical records (EMR) but added increased standards for electronic transmission of medical records to qualify for financial incentives that include a requirement for patient portals to access and interact with their medical records. (See Phase 2 of the Meaningful Use (Proposed Final Ruling released March 2012, The Health Information Technology for Economic and Clinical Health Act (HITECH Act) §13410(d) (see eg. Meaningful Use (of Health Information Technology) Proposed Final Rule March 2012 (addressing the privacy and security concerns of ePHI)))). Today, although federal regulatory mandates for network infrastructure interoperability between disparate medical entities remains very problematic, many medical entities are currently focusing on creating internal protocols in compliance with HIPAA and HITECH regulations among others. Health privacy and security experts remain quite reluctant to allow unrestricted access or data sharing with other medical entities and third parties due to security concerns and proprietary intranetwork investment interests. Moreover, under the present HITECH Act, a breach where electronic protected health information is compromised or a security vulnerability in the network architecture by one medical entity could affect all of that entity's partners and unfairly expose a medial entity to unintended liability, penalties, damages, fines, and other costs. Inasmuch, there exists is an urgent need for a third party intermediary to broker access to electronic protected health information stored in disparate medical entity proprietary intranetworks while dynamically refreshing such access in accordance with user changes, changes from algorithms executed by an medical entity's network architecture, and changes in the existing governmental laws and regulations for health information including, among others security and privacy regulations, such regulations as, among others, the Security Standards for the Protection of Electronic Protected Health Information (the Security Rule) published Feb. 20, 2003 (45 C.F.R. Part 160 and Part 164, Subparts A and C) and established standards for protecting Health Information (ePHI) conveyed by electronic means (hence “ePHI”) (hereinafter referred to as “the ePHI security rule”); the Health Insurance Portability and Accountability Act (hereafter “HIPAA”) (Health Insurance Portability and Accountability Act of 1996 (HIPAA)); Public L. 104-191, 101 Stat. 1936, enacted Aug. 21, 1996), (see also the HIPAA Privacy Rule (See 45 C.F.R. §164.530(c) (technical safeguards for ePHI)) and the HIPAA Security Rule (See 45 C.F.R §§164.308, 164.310, and 164.312 (technical safeguards for ePHI)) (HIPAA Privacy and Security Rules refer to regulations for protecting the privacy and security of health information as developed by the Secretary of the U.S. Department of Health and Human Services (HHS).)); and the Health Information Technology for Economic and Clinical Health Act (HITECH Act) §13410(d) (see eg. Meaningful Use (of Health Information Technology) Proposed Final Rule March/2012 (addressing the privacy and security concerns of ePHI)); HITECH Act as part of the American Recovery and Reinvestment Act of 2009 (ARRA), Public L. 111-5, enacted Feb. 17, 2009 (hereinafter, collectively, referred to as “The HITECH Act”).

The Meaningful Use provisions under the newly implemented HITECH Act now creates a financial incentive program for physicians and healthcare providers to adopt “meaningful use” of electronic medical records (EMR) as opposed to paper files. In effect, the “Meaningful Use” provisions have added increased standards for electronic transmission of medical records to qualify for financial incentives that are currently technically difficult and potentially quite costly to implement as many physician and healthcare provider system information technology network architectures are proprietary and incompatible with others.

To the tedious discomfort of every sick patient, this process of each healthcare system initially requiring the patient to fill out a HIPAA authorization form for accessing the patient's medical files is routinely repeated today, such as while the patient moves between healthcare systems including doctors' offices or if the patient's existing healthcare system lost the authorization form. This time-consuming, expensive, and highly bureaucratic protocol is often encouraged in that internal practices of healthcare administration from each healthcare system are different from that of most other healthcare systems. Illustratively, from a business perspective, each healthcare administration is not readily willing to share patient information while in the context of revealing sensitive aspects of that providing healthcare system's internal filing systems, procedures, and other proprietary investments to another healthcare system that create detrimental competitive and legal risks.

In this present paper-centric system, there exists no single or direct way to update access to an individual patients medical records. As patients frequently change providers or health professionals migrate between healthcare systems, the most current revisions to the paper authorization HIPAA forms for accessing a patient's medical files are always needed but rarely ever provided. Moreover, present day healthcare systems do not typically permit access to patient medical information over the internet although implementation of a patient portal is mandated for stage 2 and 3 compliance of the ARRA's “meaningful use” provisions.

Health care professionals are currently beginning to use computer based devices and software to encourage individual patients to access patient ePHI from multiple, often incompatible, medical entities via patient portals. Mobile device access to ePHI through most patient portals is achieved typically with software downloads that regrettably remain on that mobile device even after completion of a login session. Unfortunately, known patient login sessions are prohibitively cumbersome for the frail, invalid, and those individuals that have difficulty interfacing with computer based devices as well as generally adjusting to the rapidly changing technological environment.

There is a critical need for a single user login to a patient portal provided by a independent, cloud-based login service. There exists a further need to participating medical entities a system for accounting patient activity with the patient portal in compliance with government requirements such as the meaningful use requirement. There exists a need for providing patient incentives for individual patient compliance while using patient portals with respect to government regulations such as meaningful use. There exists a further need for a cloud-based patient ePHI management service including permitting patients to set privacy settings regarding their ePHI for specific participating medical entities.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

FIG. 1, in general, is a system diagram illustrating a meaningful use, single login, federated patient portal system in accordance with embodiments of the present disclosure featuring a user device, illustrated in FIG. 1 as a patient medical records kiosk, for accessing a plurality of network's patient portals provided by participating medical entities, such as EMR networks among others, through cloud based software implemented by the illustrated kiosk, thereby permitting a patient to effortlessly initiate a login session with the user device with a single unified login to the plurality of networks while the federated patient portal system provides meaningful use fulfillment credit to participating medical entities that include physicians, hospital systems, pharmacies, and laboratories upon successful authentication by the patient;

FIG. 2 is a system diagram of one embodiment of a federated patient portal system illustrating cloud based system components defining, in part, the federated patient portal system;

FIG. 3, is a system diagram of one embodiment illustrating a flow diagram associated with the unified login sequence for the federated patient portal system;

FIG. 4 is a flow diagram illustrating one exemplary method for reporting patient portal usage for each patient login session to thereby correspondingly designate a meaningful use fulfillment credit via a federated patient portal system to each participating medical entity, illustratively shown as a physician, assigned to the patient for the patient login session;

FIG. 5 is a schematic diagram of one exemplary embodiment of a user device, illustrated as a patient medical records kiosk, the patients medical records kiosk illustrates a login as a surface interface that includes various biometric sensors, among others, as well as an external memory interface for transmitting medical information including ePHI data between the patient medical records kiosk and an external memory device during a patient login session;

FIG. 6 is a schematic diagram of one exemplary embodiment of an authentication as a service interface system that includes a cloud-based, biometric registry, a login as a service display interface, and a login as a service biometric interface, whereby in operation the authentication as a service interface system permits a single sign-on enabling a patient requesting a login session to quickly, simply, and conveniently login to the federated patient portal system based on providing at least one biometric scan to gain access to a plurality of patient portals from a variety of healthcare network entities that often maintain disparate and proprietary networks of individual patient electronic medical records;

Generally, FIGS. 7-18 illustrate various embodiments of display interfaces to access a plurality of patient portals from the single source, via a federated patient portal system, for patient interaction implemented by software executed on a computer-based user device, such as among others a patient medical records kiosk of FIG. 1,

FIG. 7 is a schematic diagram illustrating one exemplary embodiment of a home patient portal interface of a federated patient portal system;

FIG. 8 is a schematic diagram illustrating one exemplary embodiment of a user profile interface for a registered user of a federated patient portal system, such as an individual patient;

FIG. 9 is a schematic diagram illustrating one exemplary embodiment of a user's (for example a patient's) insurance portal interface provided by a federated patient portal system;

FIG. 10 is a schematic diagram illustrating one exemplary embodiment of a federated patient portal system's master portal credentials list for unified login;

FIG. 11 is a schematic diagram illustrating one exemplary embodiment of a user's (for example: a patient's) profile interface from a federated patient portal system that lists the user's personal doctors;

FIG. 12 is a schematic diagram illustrating one exemplary embodiment of a user's (for example: a patient's) profile interface from a federated patient portal system that lists the user's personal hospitals or clinical systems;

FIG. 13 is schematic diagram illustrating one exemplary embodiment of a user's (for example: a patient's) profile interface from a federated patient portal system that lists the user's personal medical conditions;

FIG. 14 is a schematic diagram illustrating one exemplary embodiment of a user's (for example: a patient's) profile interface from a federated patient portal system that lists the user's personal medications;

FIG. 15 is a schematic diagram illustrating one exemplary embodiment of a user's (for example: a patient's) profile interface from a federated patient portal system that lists the user's personal listing of received surgical implants;

FIG. 16 is a schematic diagram illustrating one exemplary embodiment of a user's (for example: a patient's) profile interface from a federated patient portal system that lists the user's personal listing of undertaken surgeries;

FIG. 17 is a schematic diagram illustrating one exemplary embodiment of a user's (for example: a patient's) profile interface from a federated patient portal system that lists the user's personal list of allergens;

FIG. 18 is a schematic diagram illustrating one exemplary embodiment of a user's (for example: a patient's) profile interface from a federated patient portal system that lists the user's personal healthcare record;

FIG. 19 is a schematic diagram illustrating one exemplary embodiment biometric scanning sequence executed by a user device such as a kiosk; and

FIG. 20 is a schematic diagram illustrating one exemplary embodiment of a sequence for user authentication executed by a federated patient portal system.

The apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a system and method for healthcare administration and, in particular, enables a patient to simply provide a single login through the system as a trigger that permits the system to subsequently login to patient portals from a plurality of participant medical entities such as EMR (electronic medical records system) networks based on the single initial login, among other operations. Generally, pursuant to the various embodiments, the present disclosure provides a federated patient portal system for assigning a meaningful use credit to a corresponding participant medical entity as the patient interacts with a user device, such as among others a patient medical records kiosk. In one aspect, the patient provides a biometric input to initiate a login session with the federated patient portal system through the user device, such as a patient medical records kiosk. The biometric input enables the patient to quickly authenticate with the federated patient portal system while eliminating the need for initially providing alpha numerical text input for login.

In one aspect, the federated patient portal system includes a meaningful use accountant cloud-based software function implemented by the computer-based user device to assign meaningful use fulfillment credits to each registered participant medical entity each time a patient is successfully authenticated by the federated patient portal system when initially requesting a login session with the federated patient portal system. In one aspect, the meaningful use accountant generates a meaningful use fulfillment credit report for each requesting registered participant medical entity, such as a physician among others, whereby the report provides information regarding the assigned credits received by the requesting registered participant medical entity based on the medical entities assigned patients activity during each login session with the federated patient portal system.

In one further aspect, on receipt of successful patient authentication, a marketing data packet is provided by the federated patient portal system to a patient during a login session with the federated patient portal system whereby the marking data packet includes, among others, marketing information from a plurality participant medical entities. Optionally, at least one patient incentive is provided with the marketing data packet. In one exemplary embodiment, the patient incentive is a non-monetary, legally compliant incentive from a registered participant medical entity or a plurality of registered medical entities that illustratively includes among others a coupon, discount on products and services, a credit toward products and services, or offers for marketing promotional items.

Generally, pursuant to the various embodiments, the present disclosure provides a federated patient portal system that includes a federated patient portal management as a service modules implemented on at least one computer-based user device, such as a patient medical records kiosk, for tracking and recording each health care information file, such as a medical record or ePHI file, accessed through the federated patient portal system from the corresponding participant medical entity as such information is referenced by the successfully authenticated during a login session to the federated patient portal system. The patient accesses each record through at least one patient portal provided by the participant medical entity during the authenticated login session. Based on patient activity during the login session, such as each patient-referenced medical record that includes an ePHI file, a meaningful use fulfillment credit is assigned to the registered participant medical entity by the federated patient portal system.

Illustratively, the federated patient portal system is applicable to the field of radiology, among other fields. Accordingly, users, such as either patients or participating medical entities (such as healthcare enterprises for example a medical facility) interface with the federated patient portal system through computer-based hardware elements for implementing software components that are, in one exemplary embodiment, platformed on a cloud-based network. The hardware components for implementing software for the federated patient portal system include among others a variety of user devices (also referred to as user equipment), for example a wireless mobile device, a kiosk, and a fixed computer based workstation.

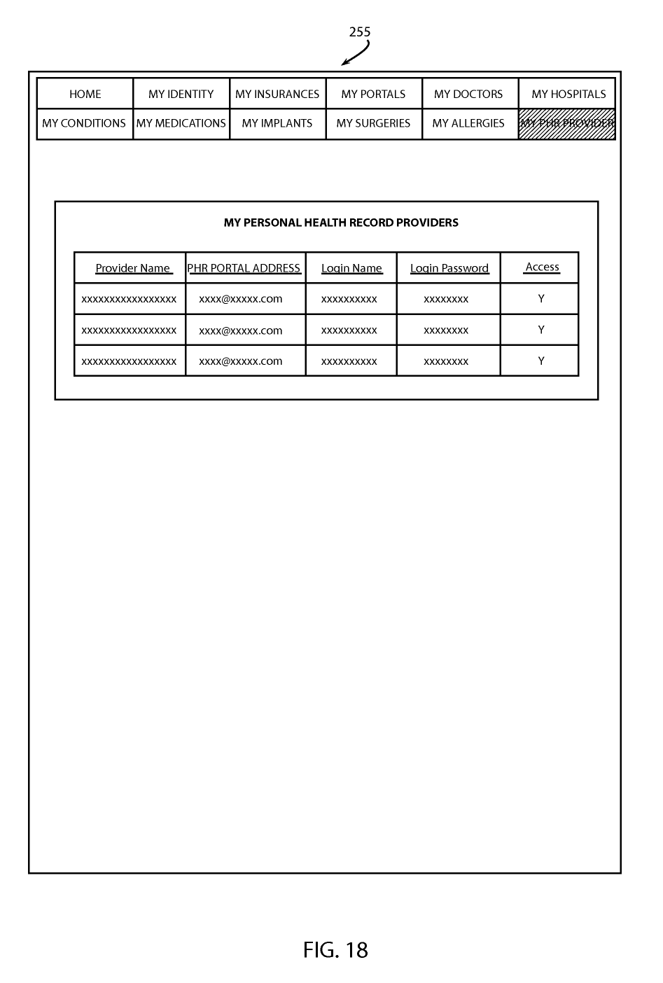

Generally, the cloud-based components of the federated patient portal system are operationally categorized in a front-end module and a back-end module. Accordingly, the front-end module is provided on a federated patient portal interface on a patient medical records kiosk for example. The front-end module permits a patient to first sign-on with the federated patient portal system by interfacing with the patient medical records kiosk to permit the patient medical records kiosk to conduct at least one biometric scan of the requesting patient for immediate single log-on to the federated patient portal system that, upon successful authentication of the patients identity, providing access to a plurality of patient portals that maintain the patients electronic health information that is often provided in non-standardized, proprietary formats. Upon successful authentication, the federated patient portal system subsequently logs into a plurality of participant medical entities patient portals based on the predetermined settings of the patient received through the patient (i.e. user) profile interface of FIG. 18.

The federated patient portal display interface provides at least one graphical user interface indicating the individual authenticated patient's medical entities that are participating on the federated patient portal system (illustratively including physicians, pharmacies, and laboratories among others), a comprehensive display of the patient's personal medical records, a privacy update manager whereby the patient selectively interacts with the private update manager to determine what personal medical files from the patient that can be accessed by participant medical entities in the course of that patient's health care. Optionally, the federated patient portal display interface further provides a list of possible new medical entities participants for the patient to select from while logged-in, illustratively including physicians, pharmacies, and practice groups among others. In one aspect, perspective new participant medical entities subscribe to the federated patient portal system to ensure that perspective participant medical entity place on the display interface for the patient to potentially select. Illustratively, in one aspect, a potential new participant medical entity subscription comprises is a paid advertisement to the operators of the federated patient portal system. Illustratively, in one aspect, that patient portal system provides at least one method of introducing medical entity providers to future patients providing information to the patient during a federated patient portal system login session. In one exemplary method, the information provided to the patient is marketing information, such as among others an advertisement. In one exemplary method, the information provided to the patient is general health information, such as among others patient-specific healthcare information that is sponsored by a medical entity provider. In one exemplary embodiment, a potential new participant medical entity registers with the federated patient portal system as a subscription for a paid advertisement to a patient that is provided by the federated patient portal system.

On the back-end module of the cloud-based components of the federated patient portal system, a medical entity meaningful use accountant module provides a meaningful use fulfillment credit notification signal to a corresponding participant medical entity as each patient logs in to the federated patient portal system through the federated patient portal display interface as well as when patient medical records provided by corresponding participant medical entities are accessed by the patient. In one aspect, the meaningful fulfillment credit notification signal notifies each corresponding participant medical entity that a pre-determined patient interaction with the federated patient portal system through the federated patient portal display interface has successfully satisfied the participant medical entities requirements under the meaningful use act and other government regulations. Optionally, the federated patient portal system may send a meaningful use fulfillment credit data packet that includes a report to a registered participant medical entity comprehensively presenting details on whether an individual patient's activity during at least one login session on the federated patient portal system has successful fulfilled the requirements of meaningful use and other government regulations to thereby award the requesting participant medical entity at least one meaningful use fulfillment credit based on such activity.

In one further aspect, a registered participant medical entity provides a marketing data packet that includes marketing information that informs at least one patient of the registered participant medical entities goods or services. Optionally, the marketing data packet includes at least one patient incentive provided by a registered participant medical entity to at least one patient during at least one login session with the federated patient portal system. At least one patient incentive includes, for nonmonetary incentives a coupon, a rebate, discount on products and services, a credit toward products and services, and offers of marketing promotional items.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Illustrative embodiments of the present disclosure and appended claims, as described below, are generally applicable to the federated patient portal system that includes user devices (or also referred to as “user equipment” (UE)), a cloud-based software components implemented through computer based user devices or user equipment (UE), and a plurality of networks including electronic medical records systems each having at least one patient portal. In one aspect, the plurality of networks includes networks based on network infrastructure of a type well known in the industry, such as Internet protocol network architecture, TCP/IP. Each of the plurality of networks based on infrastructure well known in the industry includes, among others, a number of infrastructure devices for facilitating communications for the user equipment and operating in the system. Such infrastructure devices include elements of a radio access network (RAN) or simply access network that communicate with the subscriber units via an air interface, such as for instance, eNodeBs, base radios, base stations, base transceiver stations, and the like. Such infrastructure devices further include elements of an infrastructure core (e.g., a UMTS-3G core network for a 3G or GSM/EDGE system; an Evolved Packet Core (EPC) in an LTE system etc.) used to manage the allocation of radio resources of the network, with the infrastructure core including elements such as for instance, Mobility Management Entities, Signaling Gateways, Health Level 7 (HL7) MTS adapter core engines, Packet Data Network Gateways, etc. Other infrastructure devices that may be included in any one or each of the disclosed networks includes, but are not limited to, switches, zone controllers, base station controllers, repeaters, access points, routers, etc.

In one aspect, the plurality of networks of the federated patient portal system includes networks based on network infrastructure of a type well known in the industry. Illustratively in one embodiment among others the plurality of networks includes any combination of an electronic medical system (EMRs), a pharmacy network, a social network, a hospital/clinical network, an imaging center network, a radiologic network, and a virtual private network such as among others a Picture Archiving and Communication System (PACs) and a Radiology Information System (RIS). “Medical Entity Network”, “Registered Medical Entities” or “Participant Medical Entities” includes any combination of an electronic medical system (EMRS), a pharmacy network, a social network, a hospital/clinical network, an imaging center network, a radiologic network, and a virtual private network such as among others a Picture Archiving and Communication System (PACs) and a Radiology Information System (RIS).

Illustratively, and at least in one aspect, each network from the plurality of platformed networks may comprise either a private 3G or GSM/EDGE system for supporting HL7 such as among others a hospital network 3G system or a public 3G system such as among others a commercial carrier commercial mobile phone EDGE system. Alternatively, each network from the plurality of platformed networks may comprise either a private 4G Long Term Evolution (LTE) system for supporting m-health, such as among others a hospital network 4G LTE system or a public 4G LTE system, such as among others a commercial carrier for mobile 4G LTE systems.

In at least one aspect, the plurality of platformed networks may include at least one network includes an International Mobile Telecommunications-2000 (IMT2000) based network designed to meet IMT-2000 standards, such as among others a private radiologic imaging center or a public 3G system, such as among other a commercial carrier mobile 3G systems. However, the plurality of networks can comprise any combination of 3GPP (3^{rd} Generation Partnership Project), broadband, legacy or non-3GPP radio access type systems including but not limited to LTE systems, Wireless Local Area Network (WLAN) systems, and Code Division Multiple Access (CDMA) systems, GPRS (general packet radio service) systems, Land Mobile Radio (LMR) systems, and WiMAX (Worldwide Interoperability for Microwave Access) systems. Among other messaging applications, mobile devices and other telecommunication systems are increasingly relying on internet protocols such as Session Initiation Protocol (SIP) for creating, modifying, and terminating communication sessions with one or more participants using a combination of multimedia applications, such as for voice and video.

In one aspect, the federated patient portal system is based on cloud computing infrastructure implemented by a variety of computers including for example a patient records medical kiosk that is a stand alone stationary computer based device. For purposes of illustration in this disclosure and appended claims, the federated patient portal system, comprises a self-hosted private cloud. In other aspects the federated patient portal system is applied to either a dedicated public cloud or, alternatively, a partner-hosted private cloud. Those of ordinary skill in the art will readily recognize any applicable cloud-computing infrastructure for the federated patient portal system.

At times, as described herein for purposes of this disclosure and appended claims, the terms among others “Patients”, “Medical Facilities”, “Medical Entities”, “Participant Medical Entities”, “Registered Medical Entity”, “Registered Entity”, “Authenticated User”, “Registered Patient”, “Physician”, “Healthcare Professional”, “Healthcare Administrator”, “Billing Professional”, “Heath Provider”, “Pharmacist”, “Combat Medic/Corpsman”, “Information Technology Professional”, “Technician”, “Imaging Center”, “Peer”, “Administrator”, “Originator”, “Participant”, “Node”, “User”, “User Agent Client”, “Client”, “User”, “Petitioning User”, “Requesting User”, “Subscriber(s)” and “Source/Destination Endpoint” are used interchangeably for a logical network endpoint that transmits or receives Internet Protocol messages such as among others SIP messages through a user agent server. It is understood that “user”, “participant”, or “subscriber” refers to one or more operators of user devices also known as user equipment (UE). Those of ordinary skill in the art will readily recognize various embodiments of UE, for purposes of illustration in this disclosure, the UE comprises either a wireless mobile device, such as among others a smart phone or tablet computer, or a wired device, such as among others a desktop computer, work station or a kiosk. Moreover, as described herein for purposes of this disclosure and appended claims, the terms “radiology” and “teleradiology” are used interchangeably for field of radiological medicine.

The users can be members of a “work request group”, “group” or “talk group” that include a combination of preconfigured users, ad hoc users or members. Alternatively, subscribers may not be members of such groups. As described herein, a plurality of participants or network entities in a federated patient portal system is referred to as a “network entity”, “network entities”, “network system”, “network groups”, “social network group” or “group”. A federated patient portal system features a plurality of network entities where it is possible for a user to be a member of any combination of groups and users. Illustratively, in one embodiment, a radiologist as a registered participant interacts with, such as accesses, the federated patient portal system which authenticates and optionally authorizes the radiologist so as to access a desired imaging center as a network entity, whereby the network entity is platformed with the cloud based components of the federated patient portal system that consequently login to patient portals of a plurality of EMR network entities for providing images of a desired patient. Moreover, a patient accesses the federated patient portal system for authentication to the system and illustratively access a radiologist's records from the radiologist's EMR and PAX portals for display on the federated patient portal display interface. As a further illustration, a Physician with an assigned national provider identifier (NPI) may concurrently be a member of various practice groups in addition to the radiologists own private practice group.

In this disclosure and appended claims the term “data input” and “input” refers to data that is provided through user equipment to the federated patient portal system. In particular, each user engages in a direct communication session with the federated patient portal system by way of any combination of UE comprising hardware and software and/or firmware. The UE interfaces with the cloud based vetting system such that all input is directly received by the cloud based vetting system and does not remain on the interfacing UE.

In this disclosure and appended claims, the terms “Meaningful use compliant”, refers to regulatory or other governmental incentives provided when each medical entity such as a physician encourages patient interaction with their electronic medical records under ARRA meaningful use provisions and other governmental regulations as described above. See such regulations as, among others, The Health Information Technology for Economic and Clinical Health Act (HITECH Act) of the American Recovery and Reinvestment Act of 2009 (ARRA), Public L. 111-5, enacted Feb. 17, 2009. In at least one embodiment, ePHI includes information associated with user identification and authorization.

In this application and appended claims the term “credentials”, “user login credentials” or “registration information” refers to information provided by each user on either registration or login with a federated patient portal system and such registration information includes, among others, user identification information, national provider identifier information, and authentication information.

In this application and appended claims the terms “patient portal”, refers to healthcare related software applications implemented by computers for use on the internet that allow medical patients to interact and communicate with their healthcare providers, such as physicians and hospitals, to promote interaction with those individuals patients medical information. The term “cloud computing” in this application and appended claims refers to computing models for enabling network access to a shared pool of configurable computing resources, such as among others networks, servers, storage, applications, and services.

In this application and appended claims the term “header template”, “template” allows a function application to work on many different data types without being rewritten for a user login session such that an arrangement of templates for each login session is provided, for example, at a data packet that includes a header template whereby the data packet defines, at least in part, a token. Those of ordinary skill in the art will readily recognize that other embodiments will use a “template” and “header template” for more than one login session. In this application and appended claims the term “header” or “packet header” refers to supplemental data placed at the beginning of a block of data being transmitted or stored such that data following the header is sometimes referred to as the payload or the body. Illustratively, a medical entity meaningful use accountant module from a federated patient portal system inserts a national provider identifier, NPI, meta-tag identifying the corresponding participant medical entity and as a source of transmission to and from the federated patient portal system such that the NPI data is inserted in a corresponding signal header of a data packet such as a meaningful use fulfillment credit data packet. In this application and appended claims a “packet” refers to a network packet having control data and user data or “payload”.

In this application and appended claims, the term “token” refers to at least one data packet assigned to a user of a federated login as a service module that includes user-specific information such as, among others, user authorization information and user authentication information. In one embodiment, the user-specific information is updated and synchronized. The term “meaningful use fulfillment credit” is an electronic signal transmission that includes information indicating that a receiving medical entity is in compliance pursuant to meaningful use provisions of the HITECH Act as part of the American Recovery and Reinvestment Act of 2009 (ARRA), Public L. 111-5, enacted Feb. 17, 2009 (hereinafter, collectively, referred to as “The HITECH Act”)

In this application and appended claims the term “trigger” refers to an external stimulus that engages a functional response by a federated patient portal system. In this application and appended claims the term “federated” refers to software implemented by at least one computer that is autonomous of ePHI maintained by third party software systems. Thus, a federated patient portal refers to a single portal that interfaces with a plurality of patient portals for collecting the pertinent pieces of each individual patient's heath medical record information during patient login session from disparate sources through the corresponding plurality of portals into a patient-centric, oriented collection of the medical information that is pertinent to the diagnosis and treatment process for the requesting patient. In one exemplary embodiment, there is no attempt to retain all collected medical information but in the least the directional pointers to frequently accessed data.

While embodiments of the present disclosure employ various teachings of the aforementioned standards and protocols, the embodiments as described herein are not limited by these protocols. Those skilled in the art will realize that the above recognized advantages and other advantages described herein are merely illustrative and are not meant to be a complete rendering of all of the advantages of the various embodiments.

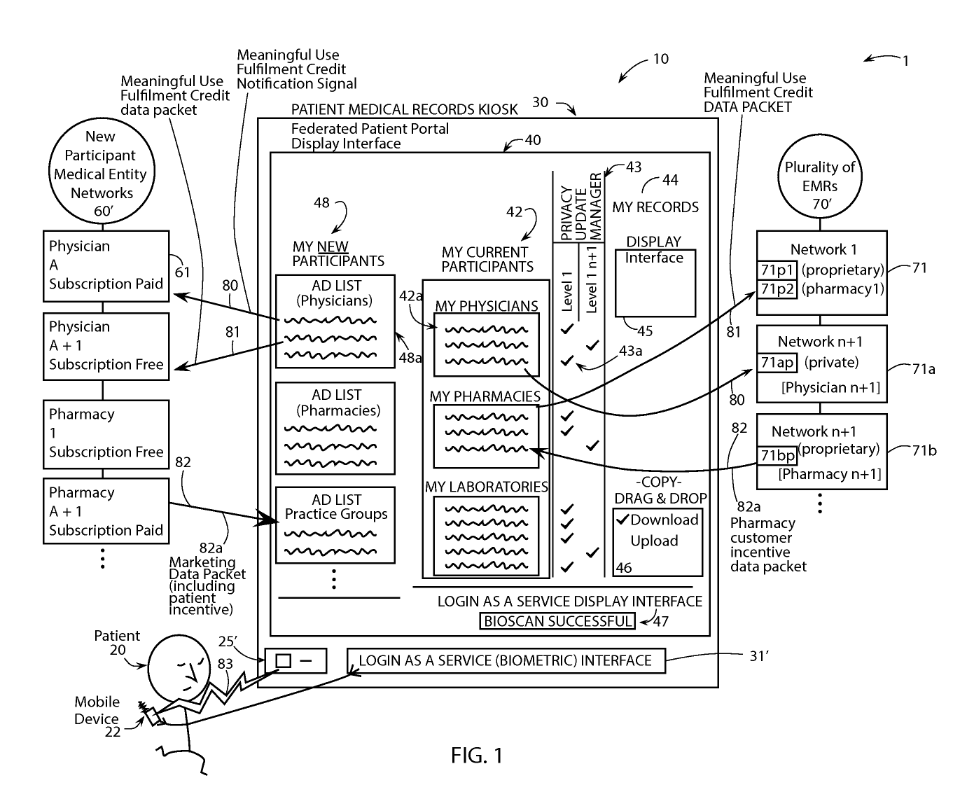

Referring now to the figures, FIG. 1 generally illustrates a meaningful use-compliant, single-login, federated patient portal system 1 (hereinafter referred to as a “federated patient portal system”) and provides a general depiction of physical implementation of various embodiments of the present disclosure including cloud-based software implemented by computers and networks of computers. Generally, in operation, the federated patient portal system 1 permits a medical patient 20 that is registered with the system 1 to electronically access personal medical records for their on-demand medical information and but also contact and interact with medical entities participating in the patient's care and well being including physicians, pharmacies, laboratories, and other providers of medical goods and services.

To access the federated patient portal system, the patient 20 interacts with a user device or also referred to as “user equipment” 10 such as among others a kiosk, a desktop computer, a tablet computer, a laptop, a wireless telecommunications device, and other well known mobile device. For the purposes of illustration in this disclosure, as shown in FIG. 1, the user device 10 is a patient medical records kiosk 30.

By providing a simple interactive input to the user device 10 such as bioscan, the federated patient portal system 1 then proceeds to authentication of the user 20 (i.e. the patient 20) based on the received bioscan in the continuing illustration to potentially initiate a login session on the federated patient portal system 1 for the requesting user 20. Upon successful authentication and initiation of a login session, the federated patient portal system 1 subsequently logs the patient 20 in to at least one patient portal each network from a plurality electronic medical records system networks maintained by corresponding participant medical entities, generally shown by reference numeral 70′, on the patient's behalf, based on pre-determined patient portal login information received by the patient see for example FIG. 18, so as to access the patient's 20 individual medical information for that login session.

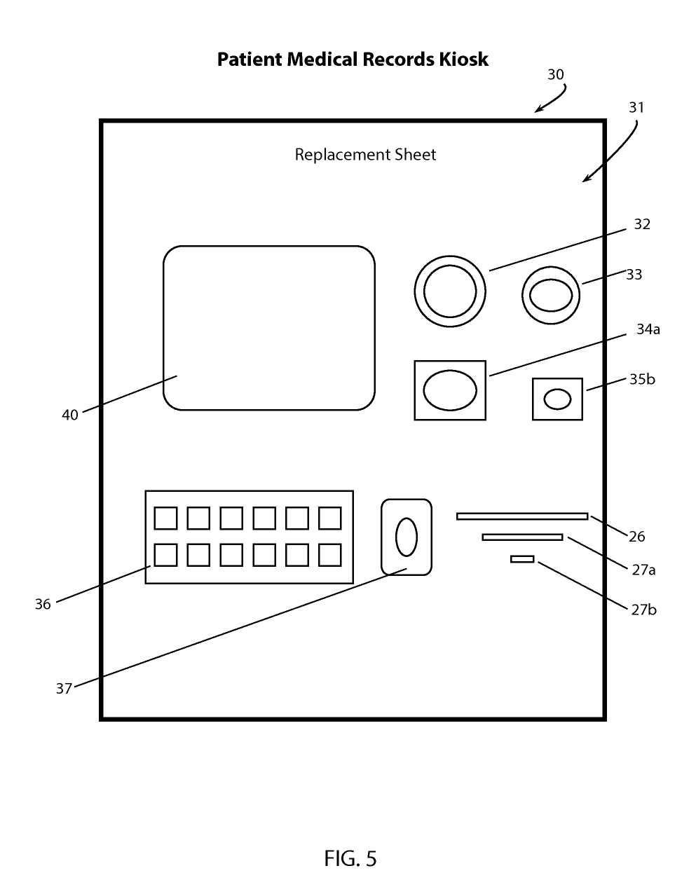

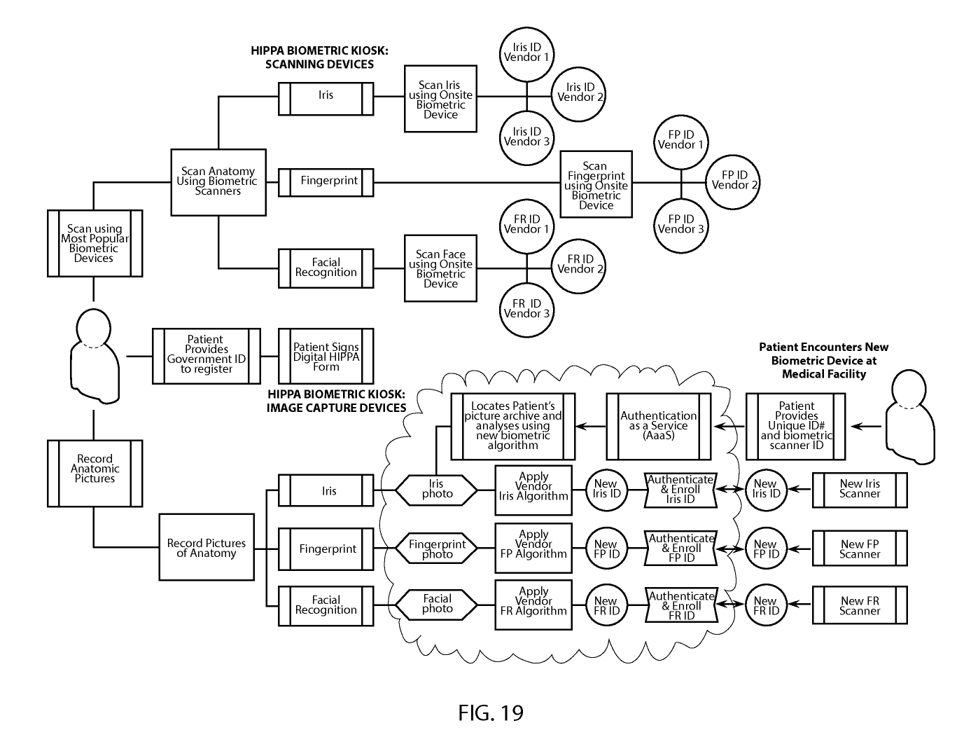

As shown in the embodiment of FIG. 1, the federated patient portal system's 1 patient medical record kiosk 30 includes a login as a service interface 31′. To promote quick and simple access to patient medical records by circumventing a patient's 20 need to provide often cumbersome and easily forgotten, individually-assigned, alphanumeric login ID's and passwords inputted through standard keyboard entry for authenticating the requesting patient 20, the login as a service interface 31′ permits the patient 20 to authenticate onto the federated patient portal system through at least one biometric reading that is prompted by the login as a surface interface 31′ to the advantageous benefit of frail patients 20, invalid patients 20 and patients 20 with difficulties with interfacing with consumer electronic technology, among others. As one example, FIG. 5 illustrates a patient's medical records kiosk 30 where the login as a service interface 31′ includes biometric input devices including among others a facial recognition processor 32, an audio processing device 33, an ocular scanner (for example a retinal scanner) scanner 34a scanner, an ocular scanner (for example an iris scanner) scanner 35b, and a skin tissue reader (for example a fingerprint scanner) 37 among others. FIG. 19 provides another example of the login as a service interface 31′ including biometric input devices.

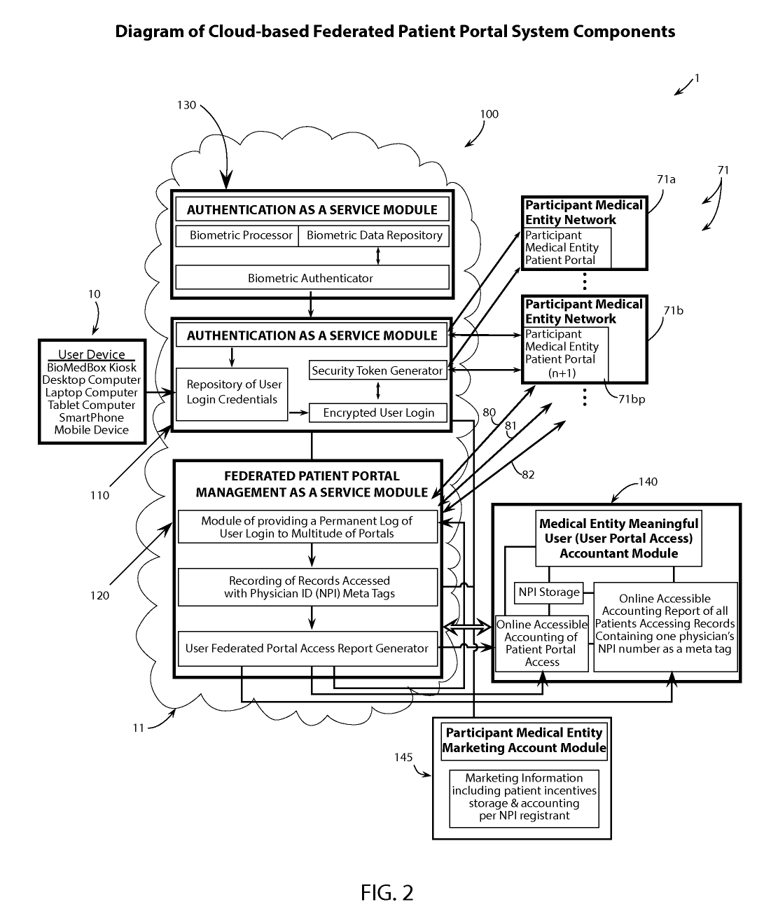

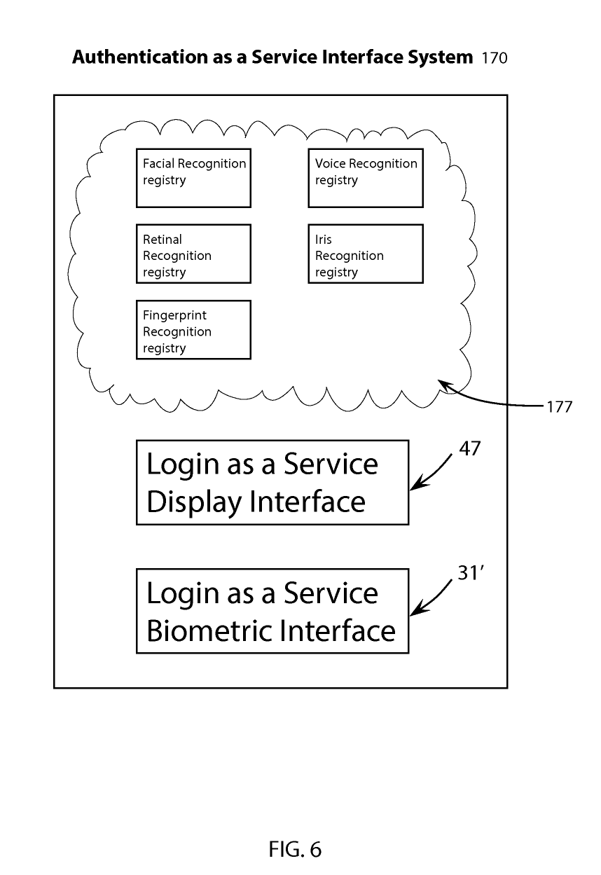

FIG. 6 illustrates an authentication as a service interface system 170. In one exemplary embodiment, the authentication as a service interface 170 provides for biometric authentication as for single source for signon by a patient 20 requesting a login session to the federated patient portal system 1 that provides a single, unifying source for subsequently logging into a plurality of patient portals to gain access to medical information on corresponding medical entity networks often providing medical information in formats that are incompatible with other networks. As shown, the authentication as a service interface system 170 includes a login as a service biometric interface 31′ for physically interacting with the requesting patient 20 to obtain at least one biometric input during login. A login as a service display interface 47 is further provided and shown in FIG. 1 as a component of the federated patient portal display interface 40. In operation, the login as a service display interface 47 displays messages for instructing the patient 20 during the biometric login sequence. The login as a service biometric interface 31′ as further shown in FIG. 1 with particular input scanners shown in FIG. 5 physically obtain the information from the patient requesting login and transmits the information to the authentication as a service module 130 shown in FIG. 2. FIG. 6 shows one illustrative embodiment of a cloud based biometric data repository 177 for maintaining updated, accurate biometric information for each registered patient 20 with the federated patient portal system 1. Accordingly, the biometric processor as well as the biometric authenticator compare at least one biometric scan received from the patient 20 requesting login with biometric login information stored within the cloud based biometric data registry 177 that illustratively includes among others a facial recognition registry, a retinal recognition registry, a fingerprint recognition registry, a voice recognition registry and an iris recognition registry.

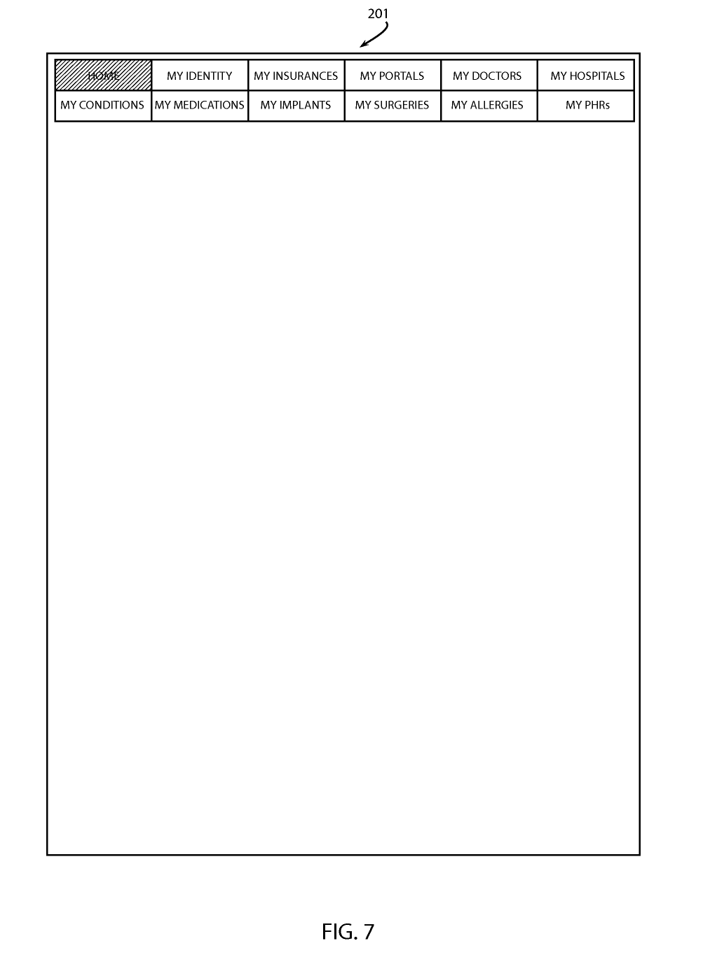

FIG. 7-18 generally provide display interfaces to access a plurality of patient portals from the single source, via a federated patient portal system, for patient interaction 200 implemented by software executed on a computer-based user device, such as among others a federated patient portal display interface 40 of a patient medical records kiosk of FIG. 1. Illustratively, the my records display as shown on FIG. 1 provides a display interface 45 such that FIG. 7-18 collectively illustrate one exemplary embodiment of graphical user interfaces displayed on the display interface 45.

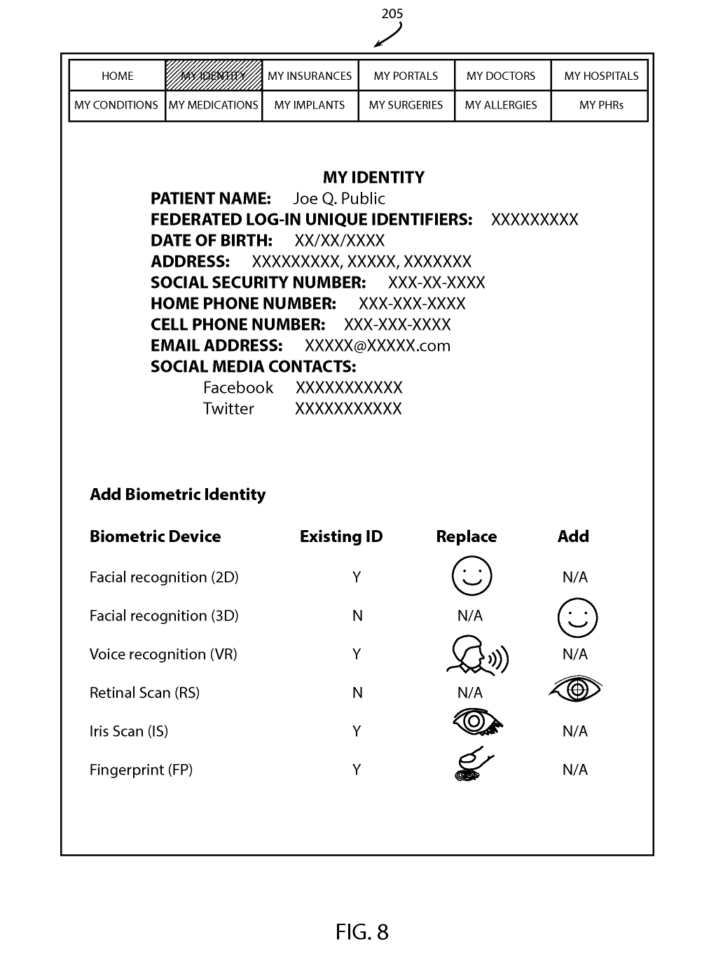

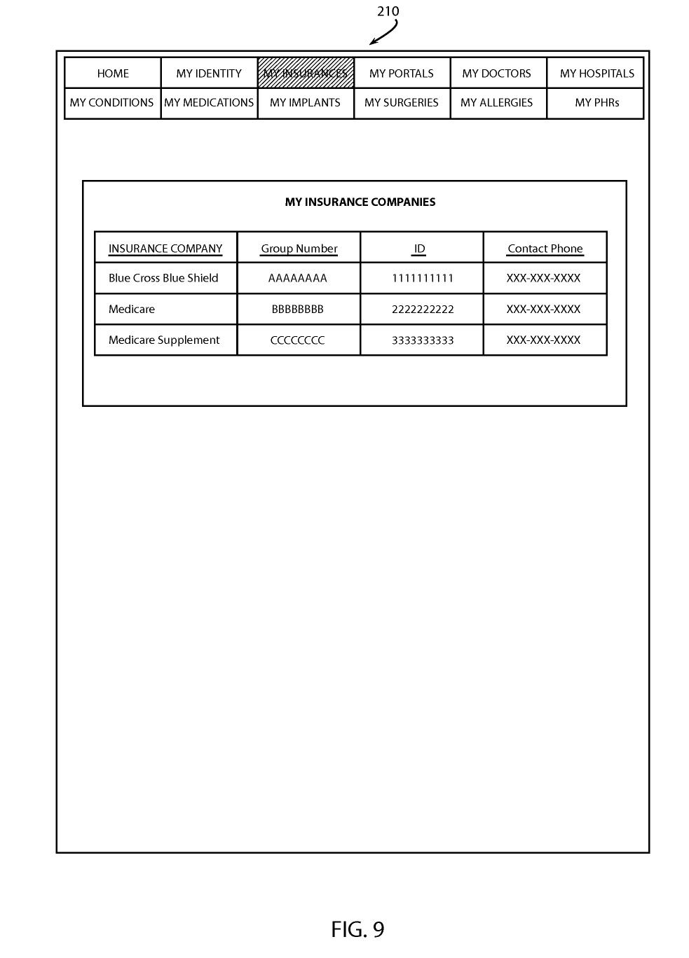

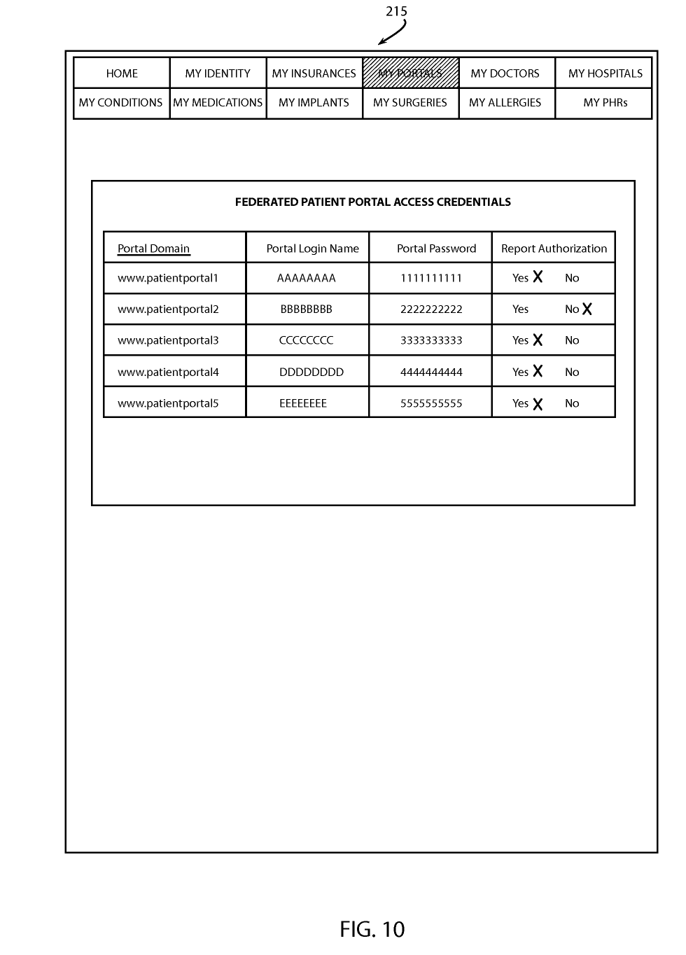

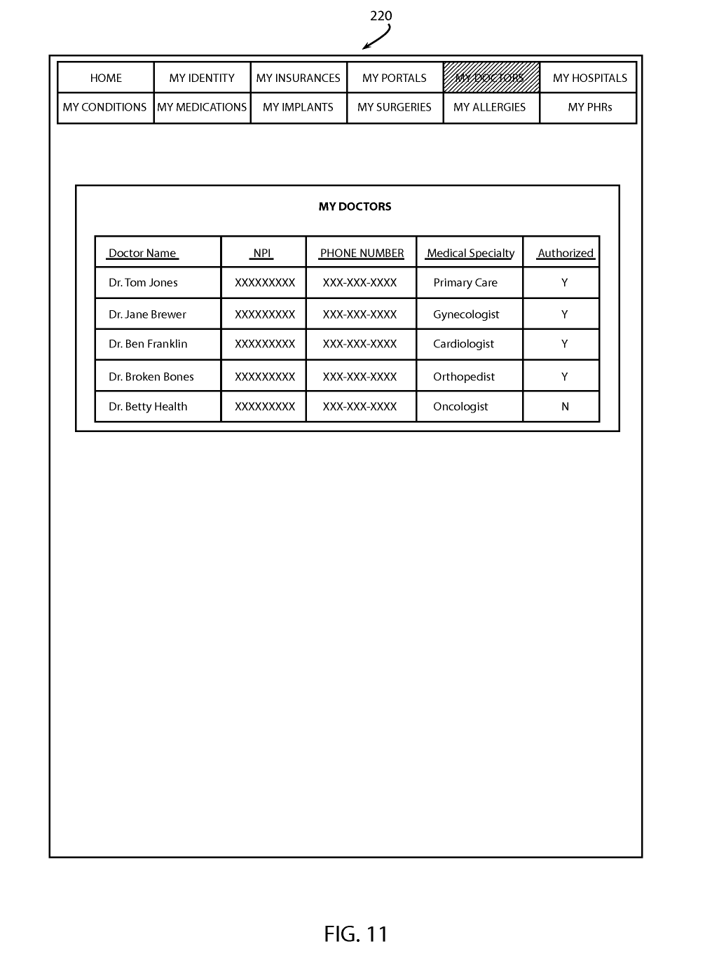

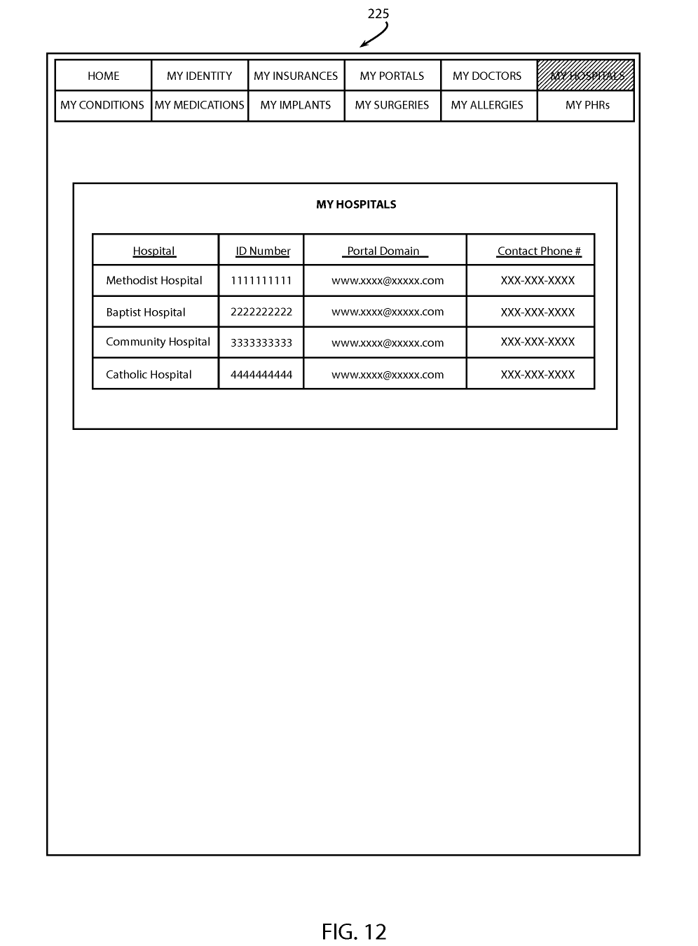

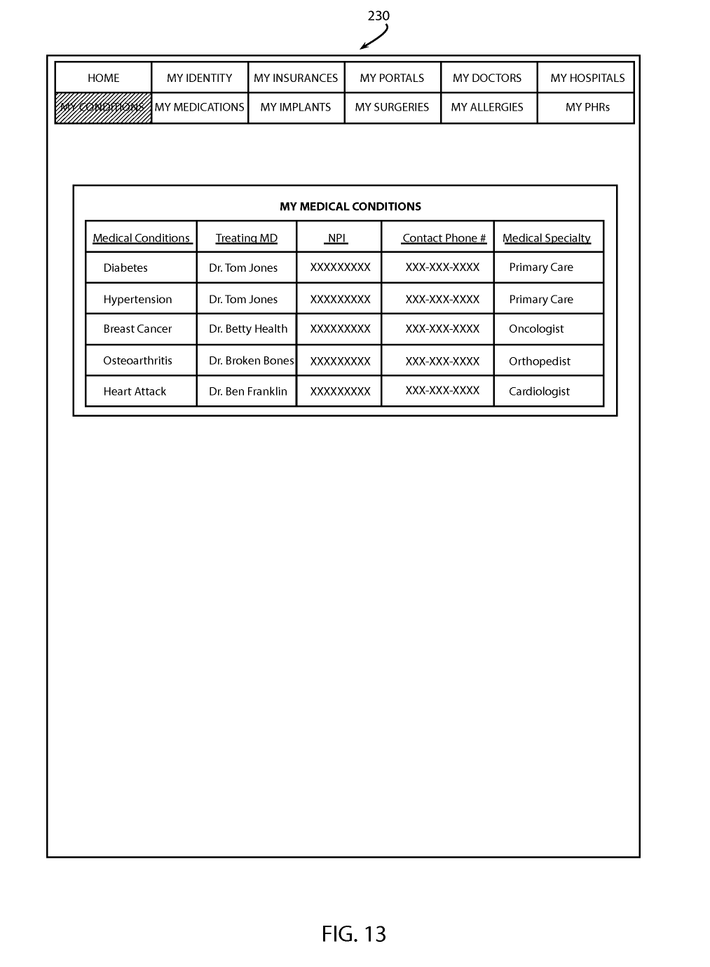

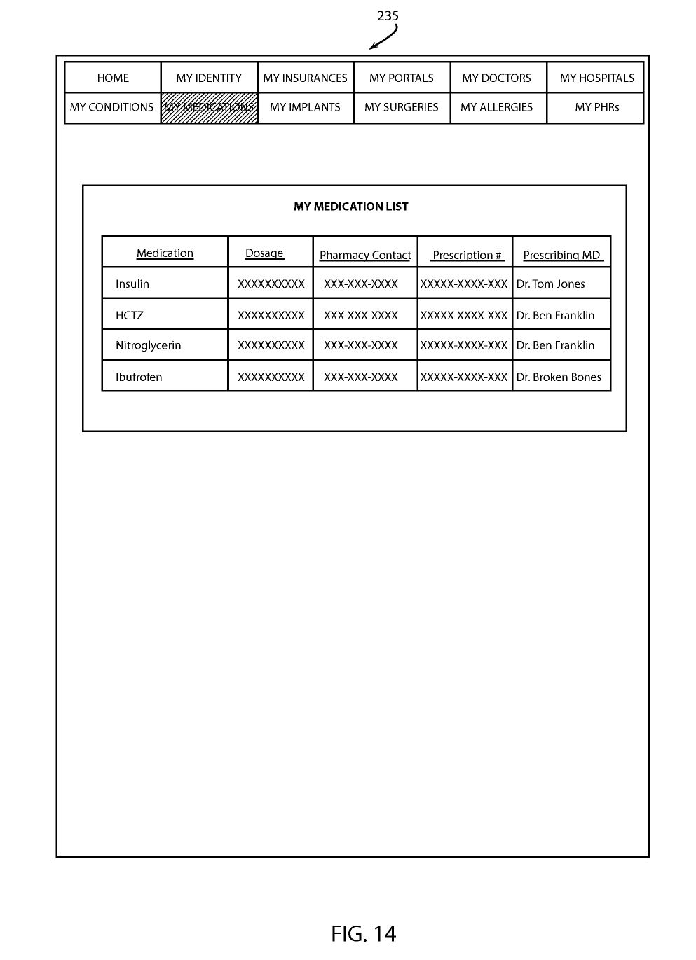

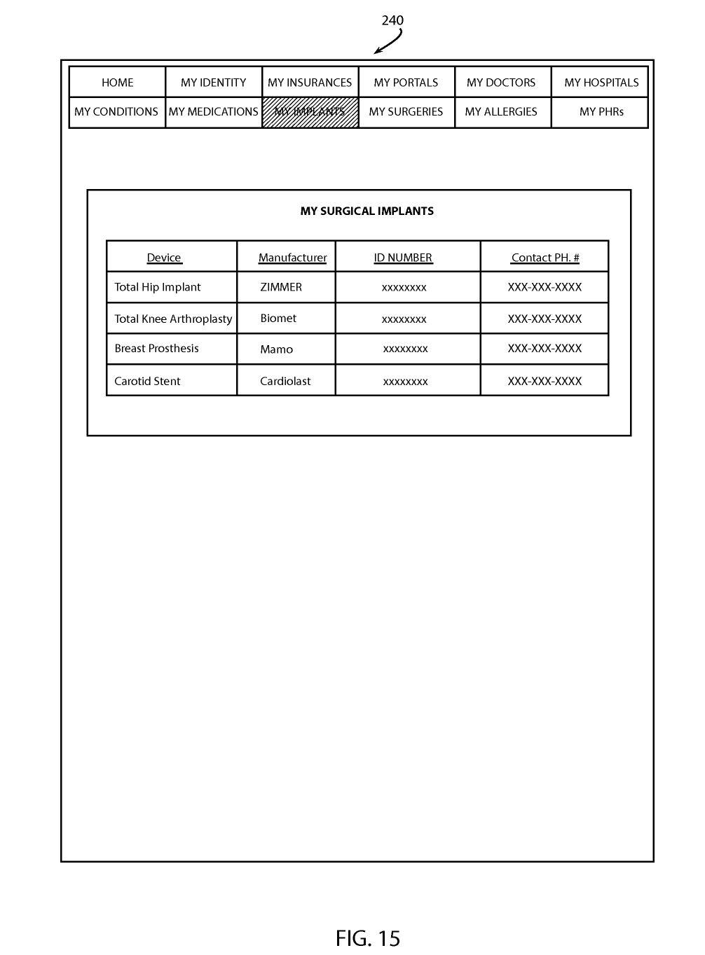

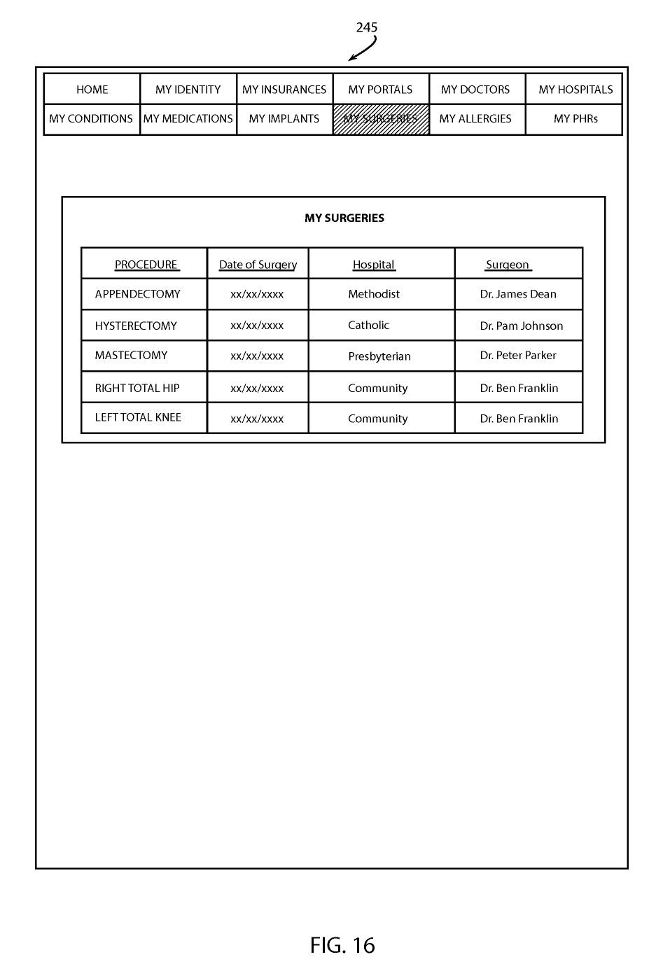

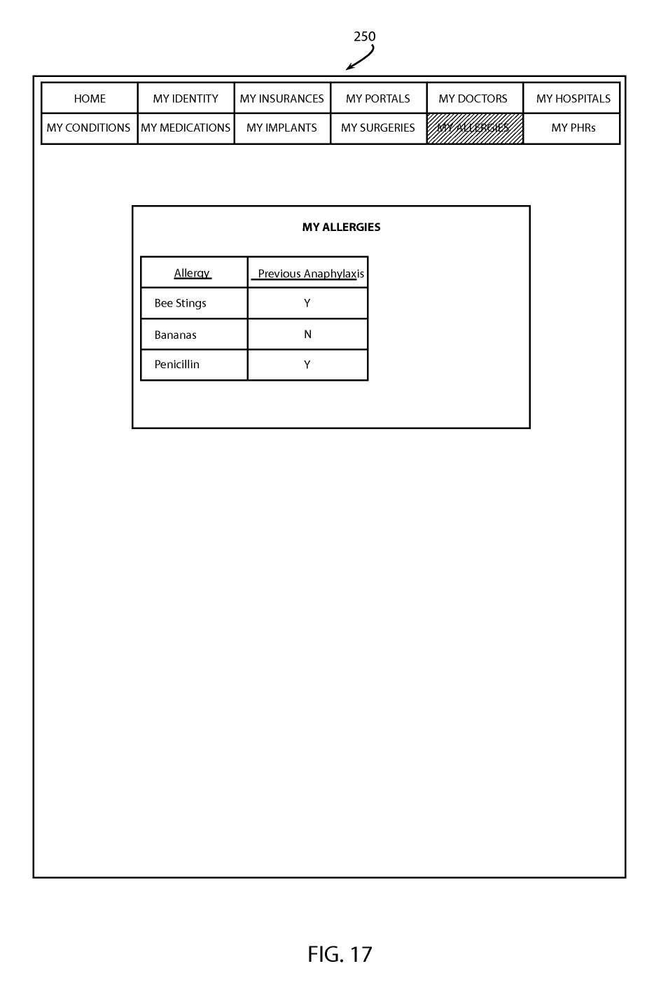

In particular, FIG. 7 illustrates a home patient portal interface 201. FIG. 8 illustrates a user profile interface 205 for a registered user of a federated patient portal system, such as an individual patient. FIG. 9 illustrates a user insurance portal interface 210. FIG. 10 illustrates a federated patient portal system's master portal credentials list for unified login 215. FIG. 11 illustrates a patient's personal doctor profile interface 220. FIG. 12 illustrates a patient's individual hospital profile interface 225. FIG. 13 illustrates a user's medical condition profile interface 230. FIG. 14 illustrates a patients medication profile interface 235. FIG. 15 illustrates a patient's personal surgical implants profile interface 240. FIG. 16 illustrates a patient's personal surgery profile interface 245. FIG. 17 illustrates a patient's individual allergies interface 250 regarding a patient's known allergen list in chronological order. And, FIG. 18 provides a comprehensive master list of all portal login information for the plurality of portals provided by participant medical entities where such interface 255 lists the portals that are signed onto after successful authentication of the requesting patient 20 is confirmed.

With further reference to FIG. 1, after the patient 20 interacts with the login as a service interface 31′, the successfully authenticated patient 20 then views their individual medical information displayed on a federated patient portal display interface 40 provided by the patient medical records kiosk 30. For the embodiment of FIG. 1, the federated patient portal display interface 40 provides displays of the following. The patient's 20 currently-assigned participant medical entities in a list format 42a that includes the individual patient's 20 current physicians, current pharmacies, current laboratories, and others. In one exemplary embodiment, the federated patient portal display interface 40 provides a display of the individual patient's 20 medical records in an edited or commonly known as a “thumbnail” form on a display interface 45 provided by the federated patient portal display interface 40.

The display interface 45 provides a comprehensive master or “unified” portal list directory of all medical entity patient portals that are opened by the patient 20 during an individual federated patient portal login session by which the corresponding source medical information such as ePHI remains maintained on the participating medical entity networks 70′ (in general), 71, 71a, 71b etc but accessed by the authenticated patient 20 during the login session through the corresponding medical entity patient portals 71p1, 71p2, 71ap, 71bp etc. while on the federated patient portal display interface 40.

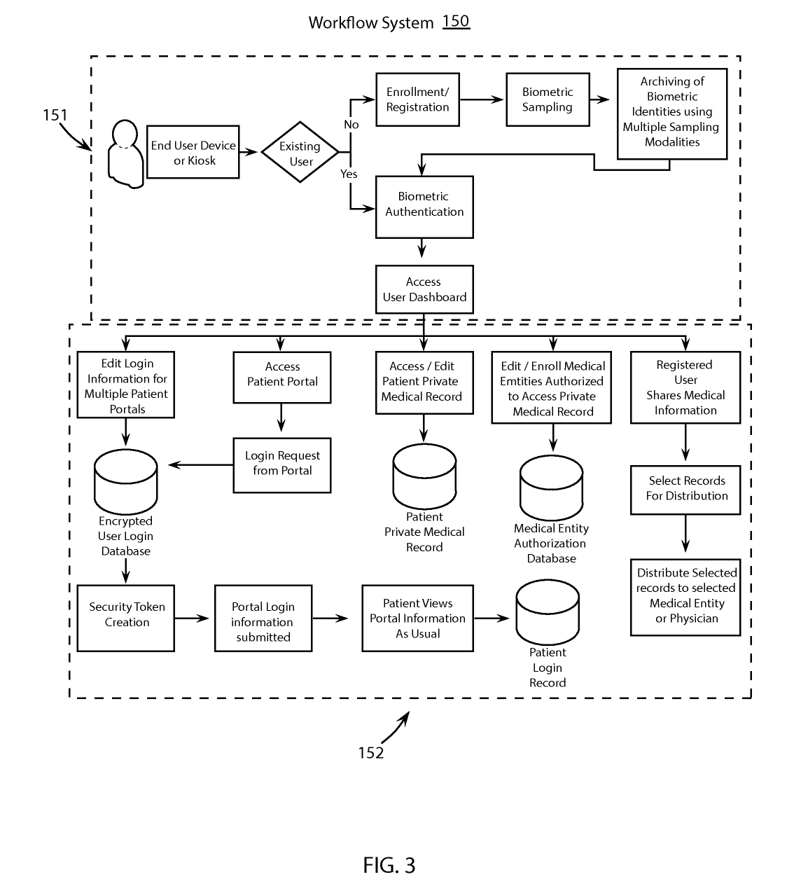

FIG. 3 is one exemplary embodiment illustrating a workflow sequence 150 flow diagram of the federated patient portal system 150 including a single login or, commonly, “signon” login sequence 151 for unified user login to a plurality of patient portals based on a single biometrically based authentication facilitated by the federated patient portal system during a login sequence for either patient or, optionally, a medical entity that desires a login session with the federated patient portal system 1. Moreover, the sequence 150 includes, among others, a federated patient portal sequence 152 for synchronizing to medical information and patient data updates and accessing medical information having embedded NPI meta-tags from a plurality of patient portals with the federated patient portal system 1.

Accordingly, FIG. 1 shows a plurality electronic medical records system networks maintained by corresponding participant medical entities, generally shown by reference numeral 70′, that provides medical information including ePHI to the requesting patient 20. In particular, FIGS. 1 and 2 show a plurality of participant medical entity networks 70′ (generally), 71, 71a, 71b etc, with respective medical information files maintained for the requesting patient 20 authenticated by the federated patient portal system 1 but include formatting that is proprietary to a particular network and or private to a particular network 70′ (in general), 71, 71a, 71b. In one exemplary embodiment the display interface 45 provides edited or commonly known as a “thumbnail” formatted, proxy files that are representative of the complete file generally stored in the a plurality electronic medical records system (EMRs) networks maintained by corresponding participant medical entities, generally shown by reference numeral 70′, such that the individual patient 20 interacts with a desired medical file on a particular network 71 through the master portal provided by the display interface 45.

As shown the federated patient portal display interface 40 further includes a copy “drag-and-drop” folder software application 46. The drag-and-drop application 46 permits a patient to copy, at least in part, an entire data file from each specific participating medical entity network 71 Accordingly, the federated patient portal system 1 then facilitates uploading of the copied data file on to an outgoing, encrypted email sent to the requesting patient or to a external memory device provided by the patient 20 while at the patient medical records kiosk 30 as illustrated in FIG. 1.

Specifically, in at least one exemplary embodiment, the patient medical records kiosk 30 includes an external memory interface 25′. Illustratively, a patient 20 interfaces with the copy drag and drop application 46 to trigger the external memory interface 25′ to wirelessly upload at least one requested patient medical record onto a nearby memory storage media provided by mobile device for example. As shown in FIG. 1, the external memory interface the wireless transfer image reference indicator 83 shows an encrypted, wireless upload to nearby storage media via an RF radio frequency (RF) (such as among others a BLUETOOTH brand technology file transfer) onto a memory card of a mobile phone 22. Alternatively, the patient medical records kiosk 30 of FIG. 5, shows other external memory interfaces 25′ in particular a external memory interface for a CD/DVD player 27a and an external memory interface for universal serial bus “USB” port 27b among others file transfer methods standard in the industry. Moreover, a document scanner 26 as well as a keyboard 36 are provided by the patient medical records kiosk 30 in part to the facilitate uploading of patient documents that are provided “in-hand” by the patient 20 to the patient medical records kiosk 30 for receipt by the federated patient portal system 1 for transfer via at least one patient portal 71p1, 71p2, 71ap, 71bp etc. to a designated participant medical entity network 70, 71, 71a, 71b, as generally indicated in FIG. 1 by the electronic medical record networks (EMRs) 70′.

The federated patient portal display interface 40 further includes a display listing of new participant medical entities 48 provided to the authorized patient 20 during an individual login session. The display listing of new participant medical entities 48 includes a list of potentially new participants 48a providing a list of individual new participant medical entities 48 for potential use of a listed individual's goods and services by the patient 20. Specifically, in one exemplary embodiment, the display listing of new participant medical entities 48 includes advertisement lists for pharmacies, medical practice groups, physicians and other medical entities providing goods and services for potential future use by the patient 20. Accordingly, in one exemplary embodiment the advertisement lists are provided by the federated patient portal display interface 40 in a display format similar to “in-print newspaper classified advertisements” for the potentially new participant medical entities.

Accordingly, as illustratively shown in FIG. 1, a physician A 61 pays a subscription fee for advertising the physician A's 61 professional medical services directly to the perspective patient 20 at the display listing of new participant medical entities 48 during the individual patient's 20 login session on the federated patient portal system 1. Alternatively, as shown in FIG. 1, a physician A+1 receives a free subscription for advertising on the federated patient portal system display interface 40 in exchange for providing general medical content to the federated patient portal system 1 as substantively helpful information regarding medical care for potential consumption by the patient 20 during the individual patient's 20 login session on the federated patient portal system 1. As shown in FIG. 1, each new participant medical entity network, generally referred to by reference numeral 60′, are in communicatively linked with the display listing of new participant medical entities 48 feature on the federated patient portal display interface 40 such that each new network participant medical entity, such as physician A 61, is accounted for and communicatively coupled with the federated patient portal system 1. By distinction, the plurality electronic medical records system (EMRs) networks maintained by corresponding participant medical entities, generally shown by reference numeral 70′, includes networks featuring patient portals 71p1, 71p2, 71ap, 71bp etc. of those participant medical entities that are being utilized by the patient 20 during a login session whereby, for example among others, the patient 20 has access to a network 71 through at least one patient portal 71p1, 71p2, 7 lap, 71bp etc. provided by the network 71.

Referring now to FIG. 2, additional components of the federated patient portal system 1 are provided on a cloud-based network architecture apart from the user device 10 hardware or, specifically, apart from the the patient medical records kiosk 30 in the continuing illustration. Generally, FIG. 2 is computer-based software implemented by the user device 10 such as the patient medical records kiosk 30. Through a federated login as a service module 110 and an authentication as a service module 130, a single unified login with a biometrically scanned input provided by the patient 20 is facilitated by the patient medical records kiosk 30. Furthermore, in compliance with the “meaningful use” requirements of the ARRA and other government regulations, the federated patient portal system 1 provides an electronically generated meaningful use fulfillment credit through cloud-based network architecture of FIG. 2 to both participant medical entities presently assigned to a patient 20 during a login session as well as new participant medical entities soliciting their goods and services on the federated patient portal system 1 during a patient login session. In one exemplary embodiment, the federated patient portal system 1 provides an electronically generated meaningful use fulfillment credit at a patient login session as a is successfully authenticated to the requested login session by the patient portal system 1 and for each medical file requested by the patient 20 during the login session among other meaningful use regulated scenarios. In operation, a medical entity meaningful use accountant module 140 accounts for each meaningful use fulfillment credit that is assigned by cloud-based network architecture of FIG. 2 to each medical entity for each patient login session onto the federated patient portal system 1.

As further shown in FIG. 2, a federated patient portal management module 120 is provided by the federated patient portal system 1 to facilitate assignment of meaningful use fulfillment credit data to at login by the patient 20 and to determine what medical records were accessed by the patient 20 during the login session to assign additional meaningful use fulfillment credits to each corresponding participant medical entity, among other operations, while the patient 20 interacts with networks featuring patient portals 71p1, 71p2, 71ap, 71bp etc. of those participant medical entities during the login session. Accordingly, the federated patient portal management as a service module 120 works in conjunction with the medical entity meaningful use accountant module 140.

Similarly, as shown in FIG. 2, the federated patient portal system 1 includes a participant medical entity marketing account module 145 that is communicatively coupled with the federated login as a service module 110, the federated patient portal management as a service module 120, and the medical entity meaningful use module 140. In operation, the participant medical entity marketing account module 145 optionally provides marketing information of a participant medical entity upon receiving successful authentication by the patient 20 from the federated login as a service module 110. Optionally, the marketing information includes at least one patient incentive 82a. The patient incentive 82a, in one exemplary embodiment, includes non-monetary, legally compliant incentives from the registered participant medical entity or plurality of registered participant medical entities including a coupon, discount on products and services, a credit toward products and services and offers for marketing promotional items.

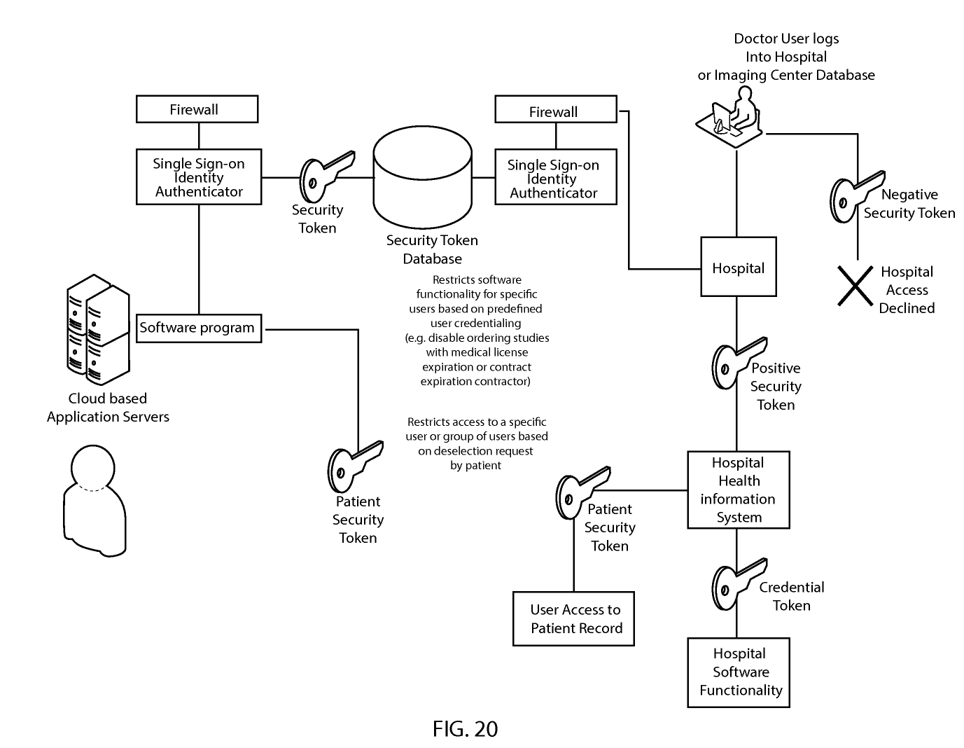

With specific reference to the modules of FIG. 2, the federated login as a service module includes among others a biometric data storage repository of user login credentials from all participants of the federated patient portal system 1 although, in alternative embodiments, the data storage repository may be accommodated by a third-party cloud-based storage service. Moreover, an encrypted user login as well as a security token generator is provided to ensure an encrypted login session that is in compliance with government regulations regarding ePHI, see FIG. 20. The encrypted user login and security token generators may be accessed from a third-party, cloud-based application-as-a-service such as among others that of an ePHI-compliant gatekeeper system and methods invented by Douglas K. Smith, M.D., Ser. No. 13/555,164 (filed Jul. 22, 2012).

Accordingly, the authentication as a service module 130 includes algorithms for authenticating a patient 20 based on bioscans received from the patient 20 at the login as a service interface 31′ of the patient medical records kiosk 30. In particular, in one exemplary embodiment, a combination of two biometric scans are provided by the patient 20 for patient authentication during a single request by the patient 20 for a login session on the federated patient portal system 1. As shown, a biometric processor compares the received biometric input with a stored repository of biometric data to authenticate the patient 20 during a login request. The authentication as a service module 130 further includes a biometric authenticator. In operation, the biometric authenticator receives the biometric input from the patient 20 during login and applies the biometric input to authentication processing algorithms facilitated by the biometric authenticator.

The medical entity meaningful use accountant module includes a data storage repository of national provider identifier (NPI) information assigned to each medical entity in compliance with HIPAA and other government regulations. On registration of each medical entity that participates with the federated patient portal system, a corresponding NPI identifier and related meta-tag is retrieved from the medical entity and maintained in the data storage repository of national provider identifier (NPI) information of the medical entity meaningful use accountant module. Each NPI identifier and corresponding meta-tag is referenced by federated patent portal system 1 during operations that account for assignment of meaningful use fulfillment credits to a corresponding medical entity based on patent 20 interactions with the federated patient portal system 1.

Generally, for each login session, the medical entity meaningful use accountant module 140 assigns meaningful use fulfillment credits to current participant medical entities currently participating in the login session, such as by providing a patient portal or an online quick consultation, as well as fulfillment credits new participant medical entities for the patients future consideration of medical goods and services. Specifically, the medical entity meaningful use accountant module 140 includes at least one processor for identifying all medical entities associated with a particular patient login session so as to assign meaningful use fulfillment credit to each medical entity on patient login authentication and other patient 20 interactions with the federated patient portal system 1. Moreover, the medical entity meaningful use accountant module includes a processor for assigning a meaningful use fulfillment credit to each medical entity whose records were accessed by the patient 20 during a login session. At least one meaningful use accountant module processor provides each medical entity a comprehensive report of meaningful use fulfillment credits acquired during login and each patient medical record interaction during that login session such that the report comprehensively provides assigned fulfillment credits obtained by the medical entity for a given quantity of patient login sessions over a period. Moreover, the participant medical entity marketing account module it includes a marketing information storage repository as well as processor for assigning the marketing information to a particular NPI registration meta-tag and transmitting such information to the patient 20 during a login session at predetermined intervals.

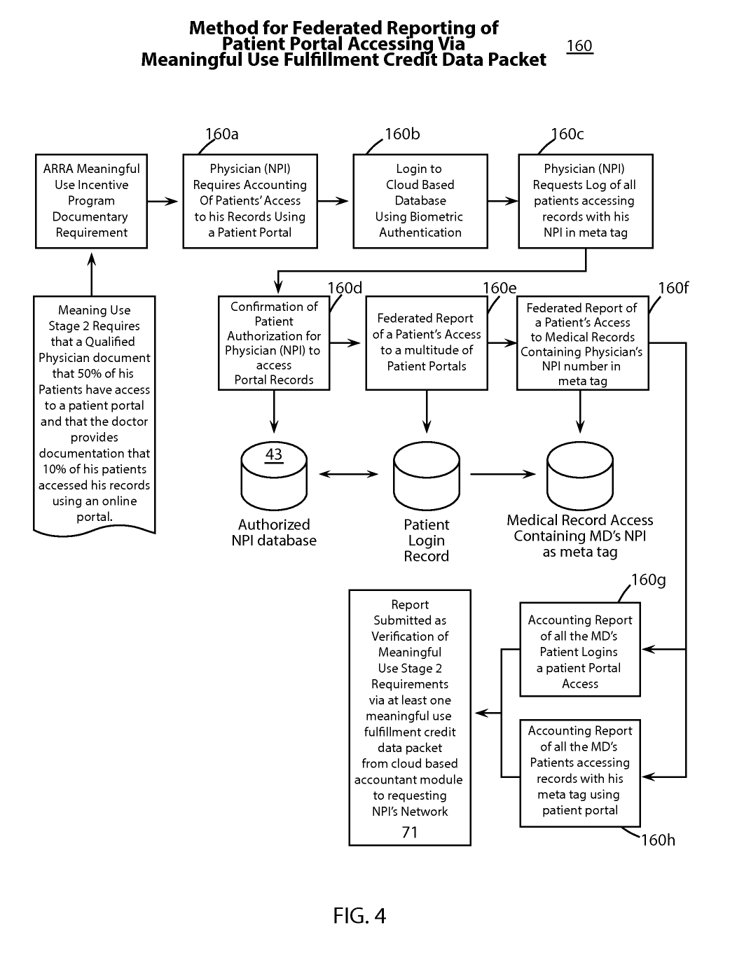

Referring now to FIG. 4, a method 160 for reporting of patient portal accessing via a meaningful use fulfillment credit notification signal 80 is provided as follows. In step 160a, a medical entity, such as a physician having an assigned NPI number, registers with the federated patient portal system 1 to request, for each patient assigned to the physician, an accounting of each patient's 20 login and access to the patient's records while using the federated patient portal system 1. In step 160b, the physician in the illustration subsequently logs into the federated patient portal system 1 after initial registration in step 160a. The physician login request is quickly and simply authenticated using the biometric authentication component of the federated patient portal system 1. In step 160c, the physician medical entity requests a comprehensive log of all patients accessing records within the physician's network via federated patient portal system 1 confirmation by tracking each record accessed by the patient whereby each record includes that physician's unique NPI identifier tag commonly embedded in the file as an NPI meta-tag that is included with the electronic file's metadata. Furthermore, as an added option, the physician could request a comprehensive accounting or “manifest” of all patients that log into the physician's patient portals as relating to the physicians unique NPI identifier tag.

In step 160d, the federated patient portal system 1 references a privacy update manager 43, as shown in FIG. 1, to confirm whether a particular patient 20 has authorized their participating physician to access specific medical information including ePHI of the patient though the plurality of portals 71p, 71p2 etc. provided by the federated medical records system 1 to plurality of medical entity networks that maintain the patient's medical records. The privacy update manager 43 permits the patients 20 to go down a list 42a of each current participant medical entity 42 and designate as a matter of patient privacy what level of private information from the patient 20 to which the selected medical entity is authorized to gain access to while accessing the patient's 20 medical files including ePHI data. For example, a strict level of privacy may be applied by the patient from any participating medial entity seeking to access information regarding drug use, HIV or AIDS medical history, and mental illness history. In one exemplary embodiment, as shown in FIG. 1, the privacy update manager 43 provides various levels of privacy filters such that a patient checks off from the list 43a a particular level of privacy measures are to be applied to each participant medical entity 42 on the list 42a.

In step 160e, the medical entity meaningful use accountant module 140 and federated patient portal management as a service module 120 collectively provide a “federated report” of a patient's successful authentication for providing access through a plurality of patient portals 71p, 71p2 etc. as shown in FIG. 1. Additionally, in step 160f, these cloud based modules 120, 140 collectively provide a federated report of a patient's interaction with each medical record containing the requesting physician medical entities NPI number incorporated within the records packet header or, alternatively embedded elsewhere in the electronic network records packet. In step 160g, the requesting physician further asks for a globally comprehensive report of all of the requesting physician's patients' login in status to the federated patient portal system 1. Similarly, in step 160H, the physician in the illustration requests an a report of all records accessed by all patients of that requesting physician based on the NPI tag inserted in the header of each record data packet. For the embodiment of FIG. 4, the federated patient portal system submits a notification to the requesting physician medical entity such that at least one meaningful use fulfillment credit notification signal 80 and or data packet is provided from at least one cloud-based component of the federated patient portal system 1 to the requesting physician on the requesting physicians network 71a.

Generally, the federated patient portal system 1 enables a patient 20 and optionally any participating medical entity registered with the federated patient portal system 1 to provide a login sequence for unified login toward a plurality of networks 70′ with corresponding patient portals in a unified manner with a single user signon. Accordingly, a computer-implemented method for accessing medical data including electronic patient health information on a user device 10 by a patient 20 is appreciated as follows.

A network communications link is initially established between the user device 10 and cloud-based components, at least in part, defining federated patient portal system 1. For example, or example the user device 10 is a patient medical records kiosk 30. The user device 10 includes a login as a service interface 31′, for example a login as a service biometric interface. The federated patient portal system 1 includes a federated login-as-a-service module 110 and an authentication-as-a-service module 130 that is communicatively coupled to the federated login-as-a-service module 110. The authentication-as-a-service module 130, in one exemplary embodiment, includes a biometric authenticator.

The patient 20 provides an input, such as a biometric input, to the login-as-a-service interface 31′, for example a login-as-a-service biometric interface. Based on the biometric input, the patient 20 is authenticated with the biometric authenticator from the authentication-as-a-service module 130. In one exemplary embodiment, the patient 20 provides a plurality of biometric inputs to the login as a service-biometric-interface 31′. Upon successful authentication the biometric indicator, the patient 20 thus logs into each network 70′. With successful authentication by the biometric indicator authenticator, a federated patient portal management as a service module 120 provided by the federated patient portal system 1 facilitates logging into each network 70′ from a plurality of electronic medical record networks where by each network is communicatively coupled to the federated patient portal management as a service module 120 and the federated login as a service module 110.

The federated patient portal system 1 displays medical information including ePHI data of the patient 20 with a display interface 45 provided by the user device 10, such as for example the patient medical records kiosk 30. The medical information including ePHI data is retrieved from the plurality of EMR networks 70′ through at least one patient portal 71p1, 71p2, 71ap provided by each EMR network 71, 71a, 71b etc. Medical information including ePHI data and specific patient medical records and files are collected from the plurality of EMR networks with the federated patient portal management-as-a-service module 120. In one exemplary embodiment, the federated patient portal management-as-a-service module 120 is a cloud-based software application implemented by computers that includes the user device 10 and whereby the user device 10 comprises a patient medical records kiosk 30. As shown in FIG. 1, an external memory interface 25′, provided by the user device 10, enables the patient 20 to copy the collected medical information including ePHI data from the federated patient portal system 1 to an external memory device such as a USB flash drive a CD-DVD for wirelessly as shown to memory within a mobile device 22.

With successful authentication by the biometric authenticator, the federated patient portal management as a service module 120 and the medical entity meaningful use accountant module 140 permits the federated patient portal system 1 to send a meaningful use fulfillment signal 80 to each medical entity network 60′, 70′, 61, 71, 71a, 71a that are registered with the federated patient portal system 1. Optionally, on successful authentication by the authentication as a service module 130, the federated patient portal management as a service module and the medical entity meaningful use accountant module 120, 140 respectively, each of the federated patient portal system 1, collectively send a meaningful use fulfillment credit data packet 81 to each medical entity network 60′, 70′, 61, 71, 71a, 71b registered with the federated patient portal system 1. In one exemplary embodiment, the meaningful use credit data packet a report includes, among others, a report of each medical entities patient logins to the federated patient portal system 1 and each record accessed by each one of the medical entities patients and other medical information accessed while on the federated portal patient system 1.

In one exemplary embodiment, for purposes of tracking each patient among other purposes, the federated login as a service module 110 provides a login security token to each network entity from the plurality of EMR networks 70′ with successful authentication confirmed by the biometric authenticator of the authentication as a service module 130. In one exemplary embodiment, for purposes of tracking each patient among other purposes, the federated login as a service module 110 provides a user login credentials to each network entity from the plurality of EMR networks 70′ with successful authentication confirmed by the biometric authenticator of the authentication as a service module 130. In one exemplary embodiment the user login security token can be supplied to the federated patient portal system 1 from a platformed, cloud-based ePHI-complaint gatekeeper system and methods provided in US patent application Ser. No. 13/555,164 (filed Jul. 22, 2012) by Douglas K. Smith, M.D.

Generally speaking, the federated patient portal system 1 provides at least one method for assigning, based on a reported successful login, a meaningful use fulfillment credit to a participant medical entity, for example, a physician while the patient interacts with the federated patient portal system 1. The at least one method is implemented by at least one computer through a user device 10, such as a patient medical records kiosk 30. The at least one method is provided for accounting for “meaningful use” regulatory compliance with respect to a corresponding participant medical entity as a patient interacts with, such as accesses, the user device is a appreciated as follows.

A network communications link is established between the user device 10, such as the patient medical records kiosk 30, and cloud-based components defining, in part, the federated patient portal system 1 in addition to the user device 10. The user device 10 includes a login as a service interface 31′, such as a biometric interface. The federated patient portal system 1 includes the following cloud-based components: a federated login as a service module 110 and a medical entity meaningful use accountant module 140 communicatively coupled to the federated login as a service module 110.

A participant medical entity, 71a, registers their information with the medical entity meaningful use accountant module 140 that includes providing the participant medical entity's assigned NPI number among other identifying information. In one exemplary embodiment, the identifying information includes, among others, biometric scans of key medical professionals within medical entity network group for example two physicians within a medical clinic each have their own individually assigned NPI number as well as own patient portal for private practice while also practicing at a clinical medical practice group with yet an additional NPI number and patient portal. Therefore, for illustrative purposes only, assume that an individual physician is the participant medical entity as the physician registers with the medical entity meaningful use accountant modeling 140 to seek individual credits for meaningful use regulatory compliance although those of ordinary skill would readily recognize other embodiments.

The patient 20 provides a one login input, such as a biometric login input, to the login as a service interface 31′ of the user device 10, 30. Based on the login input, the patient is successfully authenticated and the federated login as a service module 110 reports the successful patient authentication to the medical entity meaningful use accountant module 140. Based on the reported successful login, a meaningful use fulfillment credit is assigned to the registered participant medical entity, illustratively the individual physician, with the medical entity meaningful use accountant modules 140. During registration, a corresponding national provider identifier, NPI, (for example an NPI meta-tag) of the participant medical entity is stored in the medical entity meaningful use accountant module's 140 NPI storage repository. Optionally, during the authenticated login session, a registered participant medical entity that is currently not assigned as the patients 20 current provider can provide marketing information regarding the participant medical entities business for possible future selection by the patient 20.

A meaningful use fulfillment credit notification signal based on the assigned meaningful use fulfillment credit is generated via the medical entity meaningful use accountant module 140 to the registered participant medical entity. Optionally, in the corresponding signal header of the meaningful use fulfillment credit notification signal, an NPI meta-tag of the registered participant medical entity is inserted therein the header. A meaningful use fulfillment credit notification signal is sent to the corresponding registered participant medical entity via the medical entity meaningful use accountant module 140.

In one exemplary embodiment, a comprehensive, real-time meaningful use fulfillment credit report of the registered participant medical entity showing the assigned credits received with each patient login and/or interaction with the patient's medical information during the patient's login session is generated, in part, with the medical entity meaningful use accountant module 140. A meaningful use fulfillment credit data packet 81 is generated in part by the medical entity meaningful use accountant module 140 for the requesting, registered participant medical entity. A NPI meta-tag assigned to the registered participant medical entity is inserted into a corresponding signal header of the meaningful use fulfillment credit data packet 81. A meaningful use fulfillment credit data packet 81 based on the assigned meaningful use fulfillment credit assigned to the registered participant medical entity is generated, in part, with the medical entity meaningful use accountant 140. The medical entity meaningful use accountant module 140 generates a meaningful use fulfillment credit data packet 81 based on the comprehensive, real-time meaningful use fulfillment credit of the registered participant medical entity. The medical entity meaningful use accountant module, in part, sends the meaningful use fulfillment credit notification data packet to the corresponding registered participant medical entity.

The federated patient portal system 1 further includes a participant medical entity marketing account module 145 that is communicatively connected with the medical entity meaningful use account module 140. A new participant medical entity is registered with the federated patient portal system 1 via the participant medical entity marketing account module 145. A meaningful use fulfillment credit notification signal based on the assigned meaningful use fulfillment credit to the registered new participant medical entity is generated with the accountant module 140 a meaningful use fulfillment credit notification signal is sent by the medical entity meaningful use account module 140 to the corresponding registered participant new medical entity.

A generated marketing data packet 82 includes marketing information of the new participant medical entity as the marketing account module 145 receives a successful authentication confirmation of the patient from the federated login as the service module 110. The marketing accountant module 145 sends the marketing data packet 82 to the user device 10, 30 for access by the patient 20. In one exemplary embodiment, at least one patient incentive 82a is included with the marketing data packet 82. The patient incentive includes non-monetary, legally compliant incentive provided by a corresponding registered participant medical entity or plurality of registered participant medical entities. In one exemplary embodiment the patient incentive 82a includes among others a coupon, discount on products and services, a credit toward products and services, and offers for marketing promotional items. An NPI meta-tag of the registered participant medical entity is inserted in a corresponding signal header of the marketing data packet 82.

One exemplary, computer-implemented method for providing patient incentives while assigning a meaningful use fulfillment credit to a corresponding medical entity as the patient interacts with a user device in a manner compliant with meaningful use regulations is as follows. The method is based on software implemented by a computer-based device, such as a patient medical records kiosk or other user device 10. A network communications link is established between the user device 10, such as a patient medical records kiosk 30, and the cloud-based components, at least in part, defining the federated patient portal system 1. The user device includes a login as a service interface 31′, such as a biometric interface. Cloud-based components defining the federated patient portal system 1 include, among others, a federated login as a service module 110, a medical entity meaningful use accountant module 140 communicatively coupled to the federated login as a service module 110 and a participant medical entity marketing accountant module 145 communicatively coupled to the federated login as a service module 110 and the medical entity meaningful use accountant module 140. A participant medical entity registers with the medical entity meaningful use accountant module 140 and with the participant medical entity marketing account module 145. The patient 20 provides a login input such as biometric login input to the login as a service interface 31′ of the user device 10. As the patient 20 is successfully authenticated based on the login input, a federated login as a service module 110 reports the successful patient login to the medical entity meaningful use accountant 140. Based on the reported successful login, a meaningful use fulfillment credit is assigned to the registered participant medical entity, in part, with the medical entity meaningful use accountant module 140.

On receiving successful authentication by the patient 20 from the federated login as a service module 110 the marketing accountant module 145 generates a marketing data packet 82 including marketing information associated with the participant medical entity. On receiving successful authentication by the patient from the federated login as a service module the marketing accountant module generates a marketing data packet 82 including marketing information associated with of a plurality of participant medical entities. On receiving successful authentication by the patient 20 by the federated patient login as a service module 120, the marketing accountant module 145 generates a marketing data packet 82 including marketing information from the participant medical entity. The marketing accountant module 145 sends the marketing data packet 82 to the user device accessed by the patient.

The marketing account module 145 sends the marketing data packet 82 to the patient for display of information within the data packet on the user device 10, via a federated portal display interface 40. At least one incentive 82a is provided with the marketing data packet 82. The patient incentive includes non-monetary, legally compliant incentives from the registered participant medical entity or plurality of participant medical entities. In one embodiment the patient incentive includes a coupon, discount on products and services, a credit toward products and services, or offers for marketing promotional items. Accordingly, the federated patient portal management as a service module 120 permits the patient 20 to redeem the at least one patient per incentive at a participant medical entity patient portal of the registered participant medical entity. An NPI meta-tag of the registered participant medical entity is inserted for each corresponding header associated with each marketing data packet 82. The NPI meta-tag is associated with the registered participant medical entity.

Generally, the federated patient portal system 1 provides a federated patient portal management as a service module 110 that, in part, operates to track patient activity while signing in and interacting with medical information including the patient's ePHI during each login session. As such, the federated patient portal system provides a method for accounting for the proper assignment of meaningful use activities to those medical entities that participate within the patient's login session experience.

A computer-implemented method for patient access to medical data files in a manner compliant with meaningful use regulations is appreciated as follows. A communications link is established between a user device 10, such as a patient medical records kiosk 30, and cloud based components of the federated patient portal system as shown in FIG. 2. The user device 10 includes a login as a service interface 31′, such as a biometric interface among others. The federated patient portal system, as shown in FIG. 2, includes in part a federated login as a service module 110, a medical entity meaningful use accountant module 140 communicatively coupled to the federated login as a service module 110 and a federated portal management as a service module 120. Each participant medical entity 71a, 71b registers each patient portal with the medical entity meaningful use accountant module 140 such that the module 140 associates an NPI meta-tag of the participant medical entity with the registered patient portal. Each time a patient portal is accessed by any associated patient, the NPI meta-tag ensures that the corresponding participant medical entity receives a meaningful use fulfillment credit while the patient 20 signs-in and interacts with the federated patient portal system 1 during the login session. The patient 20 provides login input, such as at least one biometric scan at the user device 10, for receipt by the login as a service interface 31′ so as to successfully authenticate the patient 20 based on the provided login input. On receipt of successful patient authentication from the federated login as a service module 110, the federated patient portal management as a service module 120, in part, logs into at least one patient portal of the participant medical entity. Again is understood that a plurality of entities may each in turn have a plurality of patient portals. Each medical data file accessed from the participant medical entities patient portal by the successfully authenticated patient is recorded by the federated patient portal management as a service module.

Based on each patient accessed record, the medical entity meaningful use accountant assigns a meaningful use fulfillment credit to the corresponding registered participant medical entity. The federated patient portal management as a service module in part reports the accessing of each patient record to the medical entity meaningful use accountant module 140.

Based on the assigned meaningful use fulfillment credit to the registered participant medical entity the medical entity meaningful use accountant module generates a meaningful use fulfillment credit notification signal 80. An NPI meta-tag of the registered participant medical entity is inserted in a corresponding signal header of the meaningful use fulfillment credit notification signal 80. The medical entity meaningful use accountant module 140, in part, sends a meaningful use fulfillment credit notification signal 80 to the corresponding registered participant medical entity.

The medical entity meaningful use accountant module 140 generates a comprehensive, real-time meaningful use fulfillment credit report for each registered participant medical entity that includes each medical file accessed by each patient assigned to that participant medical entity. The medical entity meaningful use accountant generates a meaningful use fulfillment credit data packet 81 for the registered participant medical entity. An NPI meta-tag of the registered participant medical entity is inserted on a corresponding signal header of the meaningful use fulfillment credit data packet 81 as the medical entity meaningful use accountant generates a meaningful use fulfillment credit data packet based on the meaningful use fulfillment credit assigned to the registered participant medical entity. The medical entity meaningful use accountant generates a meaningful use fulfillment credit report for registered participant medical entity. In one embodiment the credit report includes each medical file from the participant medical entity that was accessed by each patient. The medical entity meaningful use accountant module sends a meaningful use fulfillment credit data packet 81 to the corresponding registered participant medical entity.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

I claim:

1. A computer-implemented method for accessing data on user device by a patient, the method comprising the steps of:
establishing a network communications link between the user device and a cloud-based Federated Patient Portal System, the user device including a login as a service interface, the federated patient portal system including a federated login-as-a-service module and an authentication as a service module communicatively coupled to the federated login as a service module, the authentication as a service module including a biometric authenticator;
providing a biometric input, via the patient, to the login-as-a-service interface;
authenticating the patient based on the biometric input with the biometric authenticator;
logging in to the federated patient portal system with successful authentication by the biometric authenticator; and
logging in to each network from a plurality of electronic medical record (EMR) networks with successful authentication by the biometric authenticator, each network is communicatively coupled to the federated login-as-a-service module and a federated patient portal management as a service module each provided by the federated patient portal system.

2. The computer-implemented method for accessing data on user device by a patient according to claim 1 further comprising the step of providing a plurality of biometric inputs, via the patient, to the login-as-a-service biometric interface.

3. The computer-implemented method for accessing data on user device by a patient according to claim 1 further comprising the step of providing user login credentials, via the federated login-as-a-service, to each network from the plurality of EMR networks with successful authentication by the biometric authenticator.

4. The computer-implemented method for accessing data on user device by a patient according to claim 1 further comprising the step of providing a user login security token, via the federated login-as-a-service module, to each network from the plurality medical entity networks with successful authentication by the biometric authenticator.

5. The computer-implemented method for accessing data on user device by a patient according to claim 1 further comprising the step of displaying ePHI data of the patient with the portal display interface provided by the user device, the ePHI data is retrieved from the plurality of EMR networks through at least one patient portal provided by each EMR network.

6. The computer-implemented method for accessing data on user device by a patient according to claim 1 further comprising the step of collecting ePHI data from the plurality of EMR networks with the Federated Patient Portal Management As a Service Module.

7. The computer-implemented method for accessing data on user device by a patient according to claim 6 further comprising the step of copying the collected ePHI data from the federated patient portal system to an external memory device via an external memory interface provided by the user device.

8. The computer-implemented method for accessing data on user device by a patient according to claim 1 further comprising the step of sending a meaningful use fulfillment credit notification signal from the federated patient portal system to each medical entity network registered with the federated patient portal system.

9. The computer-implemented method for accessing data on user device by a patient according to claim 1 wherein the user device comprises a patient medical records kiosk.

10. A computer-implemented method accounting for meaningful use regulatory compliance with respect to a corresponding participant medical entity as a patient interacts with a user device, the method comprising the steps of:
establishing a network communications link between the user device and a cloud based Federated Patient Portal System, the user device including a login as a service interface, the federated patient portal system including a federated login-as-a-service module and a medical entity meaningful use accountant communicatively coupled to the federated login as a service module;
registering the participant medical entity with the medical entity meaningful use accountant;
providing login input, via the patient, to the login-as-a-service interface of the user device;
authenticating the patient, successfully, based on the login input;
reporting, via the federated login-as-a-service module, the successful patient authentication to the medical entity meaningful use accountant; and
assigning, based on the reported successful login, a meaningful use fulfillment credit to the registered participant medical entity with the medical entity meaningful use accountant.

10. The computer-implemented method accounting for meaningful use regulatory compliance according to claim 10 wherein the step of registering includes the step of storing a corresponding National Provider Identifier (NPI) of the participant medical entity in the medical entity meaningful use accountant NPI storage.

11. The computer-implemented method accounting for meaningful use regulatory compliance according to claim 10 further comprising the step of generating, via the medical entity meaningful use accountant, a meaningful use fulfillment credit notification signal based on the assigned meaningful use fulfillment credit to the registered participant medical entity.

12. The computer-implemented method accounting for meaningful use regulatory compliance according to claim 11 further comprising the step of inserting a NPI meta-tag of the registered participant medical entity in a corresponding signal header of the meaningful use fulfillment credit notification signal.

13. The computer-implemented method accounting for meaningful use regulatory compliance according to claim 11 further comprising the step of sending, via the medical entity meaningful use accountant, a meaningful use fulfillment credit notification signal to the corresponding registered participant medical entity.

14. The computer-implemented method accounting for meaningful use regulatory compliance according to claim 10 further comprising the step of generating, via the medical entity meaningful use accountant, a meaningful use fulfillment credit data packet for the registered participant medical entity.

15. The computer-implemented method accounting for meaningful use regulatory compliance according to claim 14 further comprising the step of inserting an NPI meta-tag of the registered participant medical entity in a corresponding signal header of the meaningful use fulfillment credit data packet.

16. The computer-implemented method accounting for meaningful use regulatory compliance according to claim 14 further comprising the step of generating, via the medical entity meaningful use accountant, a meaningful use fulfillment credit data packet based on the assigned meaningful use fulfillment credit to the registered participant medical entity.

17. The computer-implemented method accounting for meaningful use regulatory compliance according to claim 14 further comprising the step of sending, via the medical entity meaningful use accountant, a meaningful use fulfillment credit notification data packet to the corresponding registered participant medical entity.

18. The computer-implemented method accounting for meaningful use regulatory compliance according to claim 10 further comprising the step of generating, via the medical entity meaningful use accountant, a meaningful use fulfillment credit report of the registered participant medical entity.

19. The computer-implemented method accounting for meaningful use regulatory compliance according to claim 18 further comprising the step of generating, via the medical entity meaningful use accountant, a meaningful use fulfillment credit data packet based on the meaningful use fulfillment credit report of the registered participant medical entity.

20. The computer-implemented method accounting for meaningful use regulatory compliance according to claim 10 wherein the federated patient portal system further includes a participant medical entity, marketing accountant module, the marketing accountant module is communicatively connected with the medical entity meaningful use accountant module.

22. The computer-implemented method accounting for meaningful use regulatory compliance according to claim 10 further comprising the steps of registering the participant medical entity with the participant medical entity marketing accountant module.

21. The computer-implemented method accounting for meaningful use regulatory compliance according to claim 22 further comprising the steps of:
generating, via the medical entity meaningful use accountant on receiving successful authentication by the patient from federated login-as-a-service module, a meaningful use fulfillment credit notification signal based on the assigned meaningful use fulfillment credit to the registered participant medical entity
and sending, via the medical entity meaningful use accountant and marketing accountant module, a meaningful use fulfillment credit notification signal to the corresponding registered participant medical entity of the participant medical entity marketing accountant module.

23. The computer-implemented method accounting for meaningful use regulatory compliance according to claim 22 wherein the registered participant medical entity provides marketing information regarding the participant medical entity's business for future selection by the patient.

24. The computer-implemented method accounting for meaningful use regulatory compliance according to claim 22 further comprising the step of generating a marketing data packet including marketing information of the participant medical entity via the marketing accountant module on receiving successful authentication by the patient from federated login-as-a-service module.

25. The computer-implemented method accounting for meaningful use regulatory compliance according to claim 24 further comprising the step of inserting an NPI meta-tag of the registered participant medical entity in a corresponding signal header of the marketing data packet.

26. The computer-implemented method accounting for meaningful use regulatory compliance according to claim 22 further comprising the step of generating a marketing data packet including marketing information of a plurality of participant medical entities via the marketing accountant module on receiving successful authentication by the patient from federated login-as-a-service module.

27. The computer-implemented method accounting for meaningful use regulatory compliance according to claim 22 further comprising the step of sending the marketing data packet from the marketing accountant module to the user device for access by the patient.

28. The computer-implemented method accounting for meaningful use regulatory compliance according to claim 27 further comprising the step of providing at least one patient incentive with the marketing data packet.

29. A computer-implemented method for patient interaction with a user device in a manner compliant with meaningful use regulations, the method comprising the steps of:
establishing a network communications link between the user device and a cloud based Federated Patient Portal System, the user device including a login as a service interface, the federated patient portal system including a federated login-as-a-service module, a medical entity meaningful use accountant communicatively coupled to the federated login as a service module, and a participant medical entity marketing accountant module communicatively coupled to the federated login as a service module and the medical entity meaningful use accountant;
registering a participant medical entity with the medical entity meaningful use accountant and with the participant medical entity marketing accountant module;
providing a login input, via the patient, to the login-as-a-service interface of the user device;
authenticating the patient, successfully, based on the login input;
reporting, via the a federated login-as-a-service module, the successful patient login to the medical entity meaningful use accountant; and
assigning, based on the reported successful login, a meaningful use fulfillment credit to the registered participant medical entity with the medical entity meaningful use accountant.

30. The computer-implemented method for patient interaction with a user device in a manner compliant with meaningful use regulations according to claim 29 further comprising the step of generating a marketing data packet including marketing information of the participant medical entity via the marketing accountant module on receiving successful authentication by the patient from federated login-as-a-service module.

31. The computer-implemented method for patient interaction with a user device in a manner compliant with meaningful use regulations according to claim 29 further comprising the step of generating a marketing data packet including marketing information of a plurality of participant medical entities via the marketing accountant module on receiving successful authentication by the patient from federated login-as-a-service module.

32. The computer-implemented method for patient interaction with a user device in a manner compliant with meaningful use regulations according to claim 30 further comprising the step of sending the marketing data packet from the marketing accountant module to the patient on successful authentication.

33. The computer-implemented method for patient interaction with a user device in a manner compliant with meaningful use regulations according to claim 30 further comprising the step of displaying marketing information provided by the marketing data packet on the user device.

34. The computer-implemented method for patient interaction with a user device in a manner compliant with meaningful use regulations according to claim 30 further comprising the step of providing at least one patient incentive with the marketing data packet.

35. The computer-implemented method for patient interaction with a user device in a manner compliant with meaningful use regulations according to claim 34 further comprising the step of redeeming the at least one patient incentive at a participant medical entity patient portal of the registered participant medical entity.

36. The computer-implemented method for patient interaction with a user device in a manner compliant with meaningful use regulations according to claim 30 further comprising the step of inserting an NPI meta-tag of the registered participant medical entity in a corresponding header for each marketing data packet.

37. The computer-implemented method for patient interaction with a user device in a manner compliant with meaningful use regulations according to claim 29 further comprising the steps of:
generating, via the medical entity meaningful use accountant, a meaningful use fulfillment credit notification signal based on the assigned meaningful use fulfillment credit to the registered participant medical entity, and
sending, via the medical entity meaningful use accountant and marketing accountant module, a meaningful use fulfillment credit notification signal to the corresponding registered participant medical entity of the participant medical entity marketing accountant module.

38. A computer-implemented method for patient access to medical information, including, among others, ePHI, in a manner compliant with meaningful use regulations, the method comprising the steps of:
establishing a network communications link between the user device and a cloud based Federated Patient Portal System, the user device including a login as a service interface, the federated patient portal system including a federated login-as-a-service module, a medical entity meaningful use accountant communicatively coupled to the federated login as a service module, and a federated patient portal management as a service module communicatively coupled to the a medical entity meaningful use accountant module and the federated login-as-a-service module;
registering, with the medical entity meaningful use accountant, at least one patient portal assigned to the participant medical entity;
providing login input, via the patient, to the login-as-a-service interface of the user device and authenticating the patient, successfully, based on the login input;
logging in to the at least one patient portal of the participant medical entity, via the federated patient portal management as a service module, on receipt of successful patient authentication from the federated login-as-a-service module; and
recording, via the federated patient portal management as a service module, each accessed medical data file from the participant medical entity patient portal by the successfully authenticated patient.
reporting, via the federated patient portal management as a service module, the accessing of each patient record to the medical entity meaningful use accountant; and
assigning, based on each accessed patient record, a meaningful use fulfillment credit to the registered participant medical entity with the medical entity meaningful use accountant.

39. The computer-implemented method for patient access to medical information in a manner compliant with meaningful use regulations according to claim 38 further comprising the step of generating, via the medical entity meaningful use accountant, a meaningful use fulfillment credit notification signal based on the assigned meaningful use fulfillment credit to the registered participant medical entity.

40. The computer-implemented method for patient access to medical information in a manner compliant with meaningful use regulations according to claim 38 further comprising the step of generating, via the medical entity meaningful use accountant, a meaningful use fulfillment credit data packet based on the meaningful use fulfillment credit assigned to the registered participant medical entity.

41. The computer-implemented method for patient access to medical information in a manner compliant with meaningful use regulations according to claim 38 further comprising the step of inserting an NPI meta-tag of the registered participant medical entity in a corresponding signal header of the meaningful use fulfillment credit notification signal.

42. The computer-implemented method for patient access to medical information in a manner compliant with meaningful use regulations according to claim 38 further comprising the step of sending, via the medical entity meaningful use accountant, a meaningful use fulfillment credit notification signal to the corresponding registered participant medical entity.

43. The computer-implemented method for patient access to medical information in a manner compliant with meaningful use regulations according to claim 40 further comprising the step of sending, via the medical entity meaningful use accountant, a meaningful use fulfillment credit data packet to the corresponding registered participant medical entity.

44. The computer-implemented method for patient access to medical information in a manner compliant with meaningful use regulations according to claim 38 further comprising the step of generating, via the medical entity meaningful use accountant, a meaningful use fulfillment credit report for the registered participant medical entity including each record from the participant medical entity that was accessed by the each patient.

45. The computer-implemented method for patient access to medical information in a manner compliant with meaningful use regulations according to claim 38 further comprising the step of generating, via the medical entity meaningful use accountant, a meaningful use fulfillment credit report of the registered participant medical entity including each record referenced by the each patient assigned to the participant medical entity.

46. The computer-implemented method for patient access to medical information in a manner compliant with meaningful use regulations according to claim 38 further comprising the step of generating, via the medical entity meaningful use accountant, a meaningful use fulfillment credit data packet for the registered participant medical entity.

47. The computer-implemented method for patient access to medical information in a manner compliant with meaningful use regulations according to claim 46 further comprising the step of inserting an NPI meta-tag of the registered participant medical entity in a corresponding signal header of the meaningful use fulfillment credit data packet.
